(19) United States
(12) Patent Application Publication
(10) Pub. No.: US 2022/0320514 A1
(43) Pub. Date: Oct. 6, 2022

(54) HALOGEN COMPLEXING AGENTS BOUND TO THE CATHODE SURFACE IN A STATIC ZINC HALIDE BATTERY

(71) Applicant: EOS Energy Storage LLC, Edison, NJ (US)

(72) Inventor: Rebecca Smith, Edison, NJ (US)

(73) Assignee: EOS Energy Storage LLC, Edison, NJ (US)

(21) Appl. No.: 17/703,521

(22) Filed: Mar. 24, 2022

Related U.S. Application Data
(60) Provisional application No. 63/168,699, filed on Mar. 31, 2021.

(51) Int. Cl. H01M 4/62; H01M 10/36; H01M 4/66

(52) U.S. Cl. CPC H01M 4/62; H01M 10/365; H01M 4/663; H01M 2004/029

(57) ABSTRACT

A bipolar electrode comprising a cathode substrate loaded with a halogen complexing agent that has a structure of formula Q⁺(R^{A})(R^{B})(R^{C})(R^{D})X⁻, is disclosed. The bipolar electrode also comprises a bipolar electrode plate having a cathode surface and an anode surface, wherein the cathode surface opposes the anode surface. The cathode surface at least partially contacts the cathode substrate. An electrochemical cell and a battery stack comprising the bipolar electrode, and a process for manufacturing the bipolar electrode are also disclosed.

### CROSS-REFERENCE TO RELATED APPLICATIONS

This application claims the benefit of U.S. Provisional Application No. 63/168,699, filed Mar. 31, 2021, the disclosure of which is incorporated by reference herein in its entirety.

### TECHNICAL FIELD

A rechargeable battery is described herein. In particular, a static zinc halide battery is described.

### BACKGROUND

Zinc-halide batteries were developed as devices for storing electrical energy.

Traditional zinc-halide batteries (e.g., zinc-bromine batteries) employed bipolar electrodes disposed in a static, i.e., non-flowing, zinc-bromide aqueous solution. The process of charging and discharging electrical current in a zinc-halide battery is generally achieved through a reaction of redox couples like Zn²⁺/Zn(s) and X⁻/X₂ in zinc halide electrolyte. When the battery is charged with electrical current, the following chemical reactions occur:

Zn²⁺+2e⁻→Zn

2X⁻→X₂+2e⁻,

wherein X is a halogen (e.g., Cl, Br, or I). Conversely, when the battery discharges electrical current, the following chemical reactions occur:

Zn→Zn²⁺+2e⁻

X₂₊₂e−→2X⁻.

These zinc-halide storage batteries were formed in a bipolar electrochemical cell stack, wherein each electrode comprises two poles, such that the anodic reaction occurs on one side of the electrode, and the cathodic reaction occurs on the opposite side of the same electrode. In this vein, bipolar electrodes were often configured as plates, and the cell stack was assembled to form a prismatic geometry. During charging and discharging of the bipolar battery, the electrode plates function as conductors for adjacent cells, i.e., each electrode plate serves as the anode for one cell and the cathode for the adjacent cell. In this prismatic battery geometry, the entire surface area of the electrode plate that separates adjacent electrochemical cells transfers current from cell to cell.

Accordingly, when a traditional bipolar zinc-halide battery charges, zinc metal electrolytically plates on the anode side of the bipolar electrode plate, while molecular halogen species form at the cathode side of the electrode plate. And, when the battery discharges, the plated zinc metal is oxidized to free electrons that are conducted through the electrode plate and reduce the molecular halogen species to generate halide anions.

The cathode of a traditional zinc bromine battery is required to store bromine or polybromides during charge so they are available during discharge. However, current zinc bromine batteries rely on physical trapping of the bromine or polybromide in the porous cathode, which is difficult when concentration gradients and density gradients can cause movement of the bromine and polybromides away from the cathode, rendering them unavailable during discharge. This is especially problematic in large format static zinc halide batteries as the polybromides must remain stored in the cathode for hours at a time without moving around.

### BRIEF SUMMARY

Described herein is a bipolar electrode with a cathode substrate loaded with a halogen complexing agent.

One aspect of the present disclosure relates to a bipolar electrode comprising: a bipolar electrode plate having a cathode surface and an anode surface, wherein the cathode surface opposes the anode surface; and a cathode substrate loaded with a halogen complexing agent, wherein the cathode surface at least partially contacts the cathode substrate, wherein the halogen complexing agent has a structure of Formula (I): Q⁺(R^{A})(R^{B})(R^{C})(R^{D})X⁻, wherein the variables Q, R^{A}, R^{B}, R^{C}, R^{D}, and X are as defined herein.

In some embodiments, the cathode substrate is oxidized, carbonized, graphitized, activated, or any combination thereof. The cathode substrate can be oxidized, carbonized, graphitized, activated, or any combination thereof, prior to being loaded with the halogen complexing agent. In some embodiments, the cathode substrate comprises carbon felt, graphite felt, packed carbon powder, graphite powder, expanded graphite powder, carbon foam, aerogel carbon, xerogel carbon, sol-gelated carbon, carbon cloth, carbon paper, or reticulated carbon.

In some embodiments, the cathode substrate comprises carbon felt. The carbon felt can be oxidized, carbonized, graphitized, activated, or any combination thereof. In some embodiments, the carbon felt has a thickness of from about 2 mm to about 10 mm. The carbon felt can be loaded with a concentration of the halogen complexing agent of from about 0.1 to about 100 milligrams per gram of the carbon felt.

In some embodiments, the cathode substrate comprises packed carbon powder. The carbon powder can be activated carbon, carbon black, expanded graphite, graphite, or a combination of two or more thereof.

In some embodiments, the cathode surface at least partially contacts the cathode substrate using an adhesive, an electrically conductive bonding material, a tape, a mechanical cage, or combination thereof.

In some embodiments, the loaded cathode substrate is such that the cathode substrate is chemically bonded with the halogen complexing agent. In some embodiments, the cathode substrate is chemically bonded with a monomer of the halogen complexing agent. In some embodiments, the cathode substrate is chemically bonded with a polymer of the halogen complexing agent.

In some embodiments, the halogen complexing agent is (12-dodecylphosphonic acid)triethylammonium bromide, trimethyl[3-(trimethoxysilyl)propyl]ammonium chloride, N-trimethoxysilylproply-N,N,N-tri-n-butylammonium bromide, N-trimethoxysilylundecyl-N,N,N-tri-n-butylammonium bromide, (12-Dodecylphosphonic acid)triethylammonium chloride, (12-Dodecylphosphonic acid)pyridinium bromide, (12-Dodecylphosphonic acid)N,N-Dimethyl-N-octadecyl ammonium bromide, 1-Methyl-3-(dodecylphosphonic acid)imidazolium bromide, or 1-Methyl-3-(hexylphosphonic acid)imidazolium bromide.

In some embodiments, the bipolar electrode plate comprises a titanium material. The titanium material can be at least partially coated with titanium carbide. In some embodiments, the bipolar electrode plate comprises titanium, TiC, TiN, graphite, or an electrically conductive plastic.

Second aspect of the present disclosure relates to a process for manufacturing a bipolar electrode. The process comprises the steps of mixing a halogen complexing agent and a solvent to form a mixture; contacting a cathode substrate with the mixture to form a loaded cathode substrate, wherein the cathode substrate is loaded with the mixture; and contacting at least a portion of the loaded cathode substrate with a cathodic side of a bipolar electrode plate to form the bipolar electrode. The halogen complexing agent has a structure of Formula (I): Q⁺(R^{A})(R^{B})(R^{C})(R^{D})X⁻, wherein the variables Q, R^{A}, R^{B}, R^{C}, R^{D}, and X are as defined herein.

In some embodiments, the process further comprises drying the loaded cathode substrate.

In some embodiments, the process further comprises sonicating the mixture before, during, or before and during contacting the cathode substrate with the mixture.

In some embodiments, the process further comprises treating the cathode substrate, wherein the treating is selected from oxidizing, carbonizing, activating, graphitizing, or any combination thereof. In some embodiments, the treatment step occurs before, during, or before and during contacting the cathode substrate with the mixture of the halogen complexing agent and the solvent.

In some embodiments, the solvent is water, alcohol, or combination thereof.

The halogen complexing agent in the mixture is a monomer. In some embodiments, the loaded cathode substrate is such that the cathode substrate is chemically bonded with the halogen complexing agent. In some embodiments, the cathode substrate is chemically bonded with the halogen complexing agent in its monomeric form. In some embodiments, the cathode substrate is chemically bonded with a polymer of the halogen complexing agent.

Third aspect of the present disclosure relates to an electrochemical cell comprising: a bipolar electrode comprising a bipolar electrode plate having a cathode surface and an anode surface, wherein the cathode surface opposes the anode surface; and a cathode substrate loaded with a halogen complexing agent, wherein the cathode surface at least partially contacts the cathode substrate; and an aqueous zinc-halide electrolyte, wherein the halogen complexing agent has a structure of Formula (I): Q⁺(R^{A})(R^{B})(R^{C})(R^{D})X⁻, wherein the variables Q, R^{A}, R^{B}, R^{C}, R^{D}, and X are as defined herein.

In some embodiments, the cathode substrate comprises carbon felt, graphite felt, packed carbon powder, graphite powder, expanded graphite powder, carbon foam, aerogel carbon, xerogel carbon, sol-gelated carbon, carbon cloth, carbon paper, or reticulated carbon.

In some embodiments, the halogen complexing agent is (12-dodecylphosphonic acid)triethylammonium bromide, trimethyl[3-(trimethoxysilyl)propyl]ammonium chloride, N-trimethoxysilylproply-N,N,N-tri-n-butylammonium bromide, N-trimethoxysilylundecyl-N,N,N-tri-n-butylammonium bromide, (12-Dodecylphosphonic acid)triethylammonium chloride, (12-Dodecylphosphonic acid)pyridinium bromide, (12-Dodecylphosphonic acid)N,N-Dimethyl-N-octadecyl ammonium bromide, 1-Methyl-3-(dodecylphosphonic acid)imidazolium bromide, or 1-Methyl-3-(hexylphosphonic acid)imidazolium bromide.

In some embodiments, the bipolar electrode plate comprises a titanium material. The titanium material can be at least partially coated with titanium carbide. In some embodiments, the bipolar electrode plate comprises titanium, TiC, TiN, graphite, or an electrically conductive plastic.

In some embodiments, the aqueous zinc-halide electrolyte of the electrochemical cell comprises from about 25 wt. % to about 70 wt. % of ZnBr2; from about 5 wt. % to about 50 wt. % of water; and from about 0.05 wt. % to about 10 wt. % of one or more quaternary ammonium agents.

In some embodiments, the aqueous zinc-halide electrolyte comprises from about 25 wt. % to about 40 wt. % of ZnBr₂; from about 25 wt. % to about 50 wt. % water; from about 5 wt. % to about 15 wt. % of KBr; from about 5 wt. % to about 15 wt. % of KCl; and from about 0.5 wt. % to about 10 wt. % of the one or more quaternary ammonium agents.

In some embodiments, the one or more quaternary ammonium agents comprises a quaternary agent selected from the group consisting of ammonium chloride, tetraethylammonium bromide, tetraethyl ammonium chloride, trimethylpropylammonium bromide, triethylmethyl ammonium chloride, trimethylpropylammonium chloride, butyltrimethylammonium chloride, trimethylethyl ammonium chloride, N-methyl-N-ethylmorpholinium bromide, N-methyl-N-ethylmorpholinium bromide (MEMBr), 1-ethyl-1-methylmorpholinium bromide, N-methyl-N-butylmorpholinium bromide, N-methyl-N-ethylpyrrolidinium bromide, N,N,N-triethyl-N-propylammonium bromide, N-ethyl-N-propylpyrrolidinium bromide, N-propyl-N-butylpyrrolidinium bromide, N-methyl-N-butylpyrrolidinium bromide, 1-methyl-1-butyl pyrrolidinium bromide, N-ethyl-N-(2-chloroethyl)pyrrolidinium bromide, N-methyl-N-hexylpyrrolidinium bromide, N-methyl-N-pentylpyrrolidinium bromide, N-ethyl-N-pentyl pyrrolidinium bromide, N-ethyl-N-butyl pyrrolidinium bromide, trimethylene-bis(N-methyl pyrrolidinium) dibromide, N-butyl-N-pentyl pyrrolidinium bromide, N-methyl-N-propylpyrrolidinium bromide, N-propyl-N-pentylpyrrolidinium bromide, 1-ethyl-4-methyl pyridinium bromide, 1-ethyl-2-methyl pyridinium bromide, 1-butyl-3-methylpyridinium bromide, cetyltrimethylammonium bromide, cetyltrimethylammonium chloride, cetyltriethylammonium bromide, and any combination thereof.

In some embodiments, the one or more quaternary ammonium agents comprises an alkyl substituted pyridinium chloride, an alkyl substituted pyridinium bromide, an alkyl substituted morpholinium chloride, an alkyl substituted morpholinium bromide, an alkyl substituted pyrrolidinium chloride, an alkyl substituted pyrrolidinium bromide, or any combination thereof.

Fourth aspect of the present disclosure relates to a battery stack comprising: a pair of terminal assemblies; at least one bipolar electrode interposed between the pair of terminal assemblies wherein the bipolar electrode comprises: a bipolar electrode plate; a cathode substrate loaded with a halogen complexing agent; and an aqueous zinc-halide electrolyte in contact with the bipolar electrode plate and the cathode substrate, wherein the halogen complexing agent has a structure of Formula (I): Q⁺(R^{A})(R^{B})(R^{C})(R^{D})X⁻, wherein the variables Q, R^{A}, R^{B}, R^{C}, R^{D}, and are as defined herein.

In some embodiments, the cathode substrate comprises carbon felt, graphite felt, packed carbon powder, graphite powder, expanded graphite powder, carbon foam, aerogel carbon, xerogel carbon, sol-gelated carbon, carbon cloth, carbon paper, or reticulated carbon.

In some embodiments, the halogen complexing agent is (12-dodecylphosphonic acid)triethylammonium bromide, trimethyl[3-(trimethoxysilyl)propyl]ammonium chloride, N-trimethoxysilylproply-N,N,N-tri-n-butylammonium bromide, N-trimethoxysilylundecyl-N,N,N-tri-n-butylammonium bromide, (12-Dodecylphosphonic acid)triethylammonium chloride, (12-Dodecylphosphonic acid)pyridinium bromide, (12-Dodecylphosphonic acid)N,N-Dimethyl-N-octadecyl ammonium bromide, 1-Methyl-3-(dodecylphosphonic acid)imidazolium bromide, or 1-Methyl-3-(hexylphosphonic acid)imidazolium bromide.

In some embodiments, the bipolar electrode plate comprises a titanium material.

In some embodiments, the aqueous zinc-halide electrolyte comprises from about 25 wt. % to about 70 wt. % of ZnBr₂; from about 5 wt. % to about 50 wt. % of water; and from about 0.05 wt. % to about 10 wt. % of one or more quaternary ammonium agents.

In some embodiments, the aqueous zinc-halide electrolyte comprises from about 25 wt. % to about 40 wt. % of ZnBr₂; from about 25 wt. % to about 50 wt. % water; from about 5 wt. % to about 15 wt. % of KBr; from about 5 wt. % to about 15 wt. % of KCl; and from about 0.5 wt. % to about 10 wt. % of the one or more quaternary ammonium agents.

In some embodiments, the one or more quaternary ammonium agents comprises a quaternary agent selected from the group consisting of ammonium chloride, tetraethylammonium bromide, tetraethyl ammonium chloride, trimethylpropylammonium bromide, triethylmethyl ammonium chloride, trimethylpropylammonium chloride, butyltrimethylammonium chloride, trimethylethyl ammonium chloride, N-methyl-N-ethylmorpholinium bromide, N-methyl-N-ethylmorpholinium bromide (MEMBr), 1-ethyl-1-methylmorpholinium bromide, N-methyl-N-butylmorpholinium bromide, N-methyl-N-ethylpyrrolidinium bromide, N,N,N-triethyl-N-propylammonium bromide, N-ethyl-N-propylpyrrolidinium bromide, N-propyl-N-butylpyrrolidinium bromide, N-methyl-N-butylpyrrolidinium bromide, 1-methyl-1-butyl pyrrolidinium bromide, N-ethyl-N-(2-chloroethyl)pyrrolidinium bromide, N-methyl-N-hexylpyrrolidinium bromide, N-methyl-N-pentylpyrrolidinium bromide, N-ethyl-N-pentyl pyrrolidinium bromide, N-ethyl-N-butyl pyrrolidinium bromide, trimethylene-bis(N-methyl pyrrolidinium) dibromide, N-butyl-N-pentyl pyrrolidinium bromide, N-methyl-N-propylpyrrolidinium bromide, N-propyl-N-pentylpyrrolidinium bromide, 1-ethyl-4-methyl pyridinium bromide, 1-ethyl-2-methyl pyridinium bromide, 1-butyl-3-methylpyridinium bromide, cetyltrimethylammonium bromide, cetyltrimethylammonium chloride, cetyltriethylammonium bromide, and any combination thereof.

In some embodiments, the one or more quaternary ammonium agents comprises an alkyl substituted pyridinium chloride, an alkyl substituted pyridinium bromide, an alkyl substituted morpholinium chloride, an alkyl substituted morpholinium bromide, an alkyl substituted pyrrolidinium chloride, an alkyl substituted pyrrolidinium bromide, or any combination thereof.

In some embodiments, a self-discharge rate of the battery stack described herein is reduced by about 29% to about 34% in a single cycle compared to an equivalent battery stack without a halogen complexing agent.

### BRIEF DESCRIPTION OF DRAWINGS

These and other features, aspects, and advantages of the device described herein will become better understood when the following detailed description is read with reference to the accompanying drawings.

FIG. 1 shows an exploded view of an electrochemical cell according to an aspect of what is described.

FIGS. 2A and 2B are front and side views, respectively, of a bipolar electrode according to an aspect of what is described.

FIG. 3 shows an exploded view of a bipolar electrode according to an aspect of what is described.

FIG. 4A shows a front view of a bipolar electrode according to an aspect of what is described.

FIG. 4B shows an exploded view of a bipolar electrode according to an aspect of what is described.

FIG. 5 shows a view of the back surface of an electrode plate having a sandblasted area 217 according to an aspect of what is described.

FIGS. 6A and 6B show a front and side view, respectively, of a cathode cage according to an aspect of what is described.

FIGS. 7A and 7B show a front view of a cathode cage and a magnified view of a cathode cage material having holes therethrough, respectively, according to an aspect of what is described.

FIG. 8 shows a cross-sectional view of a portion of an electrochemical cell including an interface between a front surface of a bipolar electrode plate (including the cathode assembly mounted thereon) and the back surface of a second electrode plate or an inner surface of a terminal endplate according to an aspect of what is described.

FIG. 9 shows a front, side, and top perspective view of a loaded carbon felt for use as a cathode substrate according to an aspect of what is described.

FIG. 10 shows a top perspective view of a terminal assembly for a bipolar battery according to an aspect of what is described.

FIG. 11 shows an exploded view of the terminal assembly of FIG. 10 according to aspect of what is described.

FIG. 12 shows a side view of a battery stack according to an aspect of what is described.

FIG. 13 shows an exploded view of the battery stack of FIG. 12 according to an aspect of what is described.

FIG. 14 shows a front view of a battery frame member for use in the battery stack of FIG. 12 according to an aspect of what is described.

FIG. 15 shows a close-up sideview of the bottom of the battery frame member of FIG. 14 according to an aspect of what is described.

FIG. 16 shows examples of the self-assembled monolayers bound to the oxidized surface (e.g., the cathode substrate) using two different examples of halogen complexing agents as described herein.

FIG. 17 shows a plot of the average discharge capacity vs. cycle index for three populations of cells containing either untreated control felt (“Untreated”) or felts loaded with one of the exemplary halogen complexing agents (“Silane Treated” or “Phosphate Treated”) described herein.

### DETAILED DESCRIPTION

Embodiments of the present disclosure are described in detail with reference to the drawing figures wherein like reference numerals identify similar or identical elements. It is to be understood that the disclosed embodiments are merely examples of the disclosure, which may be embodied in various forms. Well-known functions or constructions are not described in detail to avoid obscuring the present disclosure in unnecessary detail. Therefore, specific structural and functional details disclosed herein are not to be interpreted as limiting, but merely as a basis for the claims and as a representative basis for teaching one skilled in the art to variously employ the present disclosure in virtually any appropriately detailed structure.

### I. DEFINITIONS

As used herein, the term “electrochemical cell” or “cell” are used interchangeably to refer to a device capable of either generating electrical energy from chemical reactions or facilitating chemical reactions through the introduction of electrical energy. An electrochemical cell may be a bipolar electrochemical cell, a terminal electrochemical cell, or a lab cell.

As used herein, the term “battery” encompasses electrical storage devices comprising at least one electrochemical cell. For example, a battery may be comprised of 40 electrochemical cells in series. A “secondary battery” is rechargeable, whereas a “primary battery” is not rechargeable. For secondary batteries described herein, a battery anode is designated as the positive electrode during discharge, and as the negative electrode during charge.

As used herein, an “electrolyte” refers to a substance that behaves as an electrically conductive medium. For example, the electrolyte facilitates the mobilization of anions and cations in the cell. Electrolytes include mixtures of materials such as aqueous solutions of metal halide salts (e.g., ZnBr₂, ZnCl₂, or the like).

As used herein, the term “electrode” refers to an electrical conductor used to make contact with a nonmetallic part of a circuit (e.g., a semiconductor, an electrolyte, or a vacuum). An electrode may also refer to either an anode or a cathode.

As used herein, the term “anode” refers to the negative electrode from which electrons flow during the discharging phase in the battery. The anode is also the electrode that undergoes chemical oxidation during the discharging phase. However, in secondary, or rechargeable, cells, the anode is the electrode that undergoes chemical reduction during the cell's charging phase. Anodes are formed from electrically conductive or semiconductive materials, e.g., metals (e.g., titanium or TiC coated titanium), metal oxides, metal alloys, metal composites, semiconductors, or the like.

As used herein, the term “cathode” refers to the positive electrode into which electrons flow during the discharging phase in the battery. The cathode is also the electrode that undergoes chemical reduction during the discharging phase. However, in secondary or rechargeable cells, the cathode is the electrode that undergoes chemical oxidation during the cell's charging phase. Cathodes are formed from electrically conductive or semiconductive materials, e.g., metals, metal oxides, metal alloys, metal composites, semiconductors, or the like.

As used herein, the term “bipolar electrode” refers to an electrode that functions as the anode of one cell and the cathode of another cell. For example, in a battery, a bipolar electrode functions as an anode in one cell and functions as a cathode in an immediately adjacent cell. In some examples, a bipolar electrode comprises two surfaces, a cathode surface and an anode surface, wherein the two surfaces are connected by a conductive material. For instance, a bipolar electrode plate may have opposing surfaces wherein one surface is the anode surface, the other surface is the cathode surface, and the conductive material is the thickness of the plate between the opposing surfaces.

As used herein, the term “halide” refers to a binary compound of a halogen with another element or radical that is less electronegative (or more electropositive) than the halogen, to make a fluoride, chloride, bromide, iodide, or astatide compound.

As used herein, the term “halogen” refers to any of the elements fluorine, chlorine, bromine, iodine, and astatine, occupying group VIIA (17) of the periodic table. Halogens are reactive nonmetallic elements that form strongly acidic compounds with hydrogen, from which simple salts can be made.

As used herein, the term “anion” refers to any chemical entity having one or more permanent negative charges. Examples of anions include, but are not limited to fluoride, chloride, bromide, iodide, arsenate, phosphate, arsenite, hydrogen phosphate, dihydrogen phosphate, sulfate, nitrate, hydrogen sulfate, nitrite, thiosulfate, sulfite, perchlorate, iodate, chlorate, bromate, chlorite, hypochlorite, hypobromite, carbonate, chromate, hydrogen carbonate (bicarbonate), dichromate, acetate, formate, cyanide, amide, cyanate, peroxide, thiocyanate, oxalate, hydroxide, and permanganate.

As used herein, a “titanium material” may include, but is not limited to, titanium (in any oxidation state), TiC, alloys of TiC such as TiCₓM (where x is 0, 1, 2, 3, or 4 and M is a metal), titanium carbohyrides, non-stoichiometric titanium-carbon compounds, and combinations thereof.

As used herein, “titanium carbide” is used interchangeably with “titanium carbide material” and includes, but is not limited to TiC, alloys of TiC such as TiC_{X}M (where x is 0, 1, 2, 3, or 4 and M is a metal), titanium carbohydrides, non-stoichiometric titanium-carbon compounds, and combinations thereof.

As used herein, the term “zinc metal” refers to elemental zinc, also commonly known as Zn(0) or Zn°.

As used herein, the term “quaternary ammonium agent” refers to any compound, salt, or material comprising a quaternary nitrogen atom. For example, quaternary ammonium agents include ammonium halides (e.g., NH₄Br, NH₄Cl, or any combination thereof), tetra-alkylammonium halides (e.g., tetramethylammonium bromide, tetramethylammonium chloride, tetraethyl ammonium bromide, tetraethylammonium chloride, alkyl-substituted pyridinium halides, alkyl-substituted morpholinium halides, combinations thereof or the like), heterocyclic ammonium halides (e.g., alkyl-substituted pyrrolidinium halide (e.g., N-methyl-N-ethylpyrrolidinium halide or N-ethyl-N-methylpyrrolidinium halide), alkyl-substituted pyridinium halides, alkyl-substituted morpholinium halides, viologens having at least one quaternary nitrogen atom, combinations thereof, or the like), or any combination thereof. Tetra-alkylammonium halides may be symmetrically substituted or asymmetrically substituted with respect to the substituents of the quaternary nitrogen atom.

As used herein, the term “weight percent” and its abbreviation “wt. %” or “wt %” are used interchangeably to refer to the product of 100 times the quotient of mass of one or more components divided by total mass of a mixture or product containing said component:

wt %=100%×(mass of component(s)/total mass)

When referring to the concentration of components or ingredients for electrolytes, as described herein, wt. % (or wt %) is based on the total weight of the electrolyte.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” comprises any and all combinations of one or more of the associated listed items.

The terms, upper, lower, above, beneath, right, left, etc. may be used herein to describe the position of various elements with relation to other elements. These terms represent the position of elements in an example configuration. However, it will be apparent to one skilled in the art that the battery frame member may be rotated in space without departing from the present disclosure and thus, these terms should not be used to limit the scope of the present disclosure.

As used herein, “plurality” refers to two or more of the elements being described. In some embodiments, plurality refers to three or more, four or more, or five or more of the elements being described.

As used herein, “chemically compatible” refers to a material that does not interfere with the chemistry of an electrochemical cell in a way that meaningfully negatively impacts the performance of the electrochemical cell. The chemically compatible material is chemically compatible with electrolyte (e.g., zinc-halide electrolyte, alkaline electrolyte) and anode and cathode materials.

As used herein, “chemically inert” refers to a material that does not chemically react in any meaningful way with the electrolyte, anode, or cathode of an electrochemical cell.

### II. ELECTROCHEMICAL CELL AND BATTERY STACK

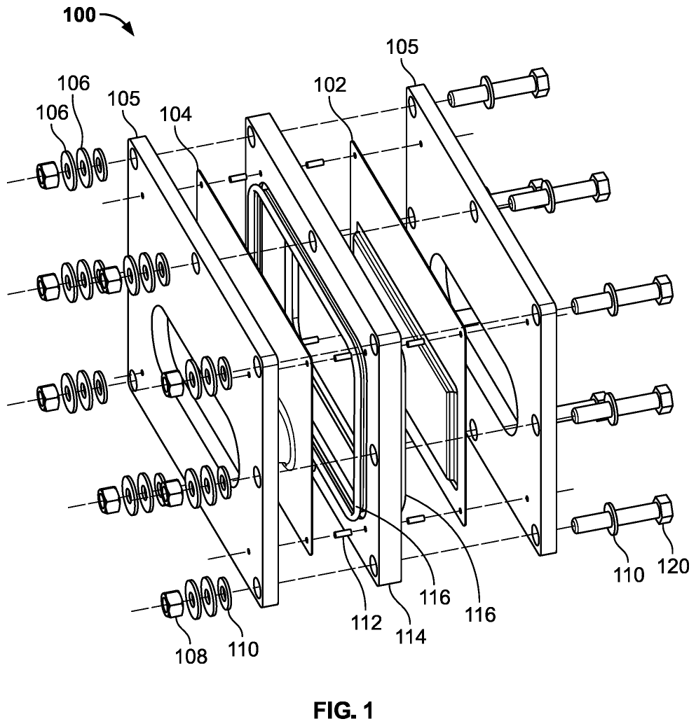

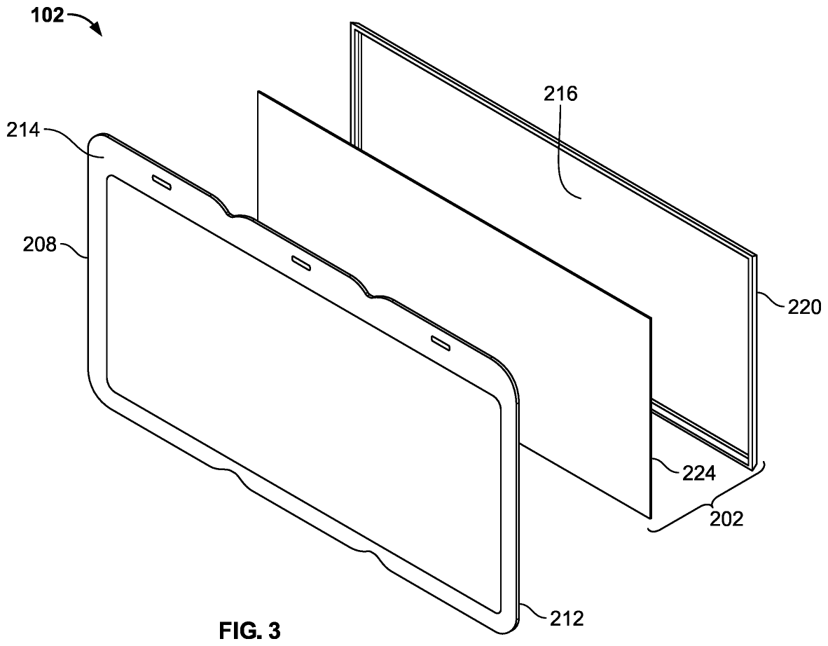

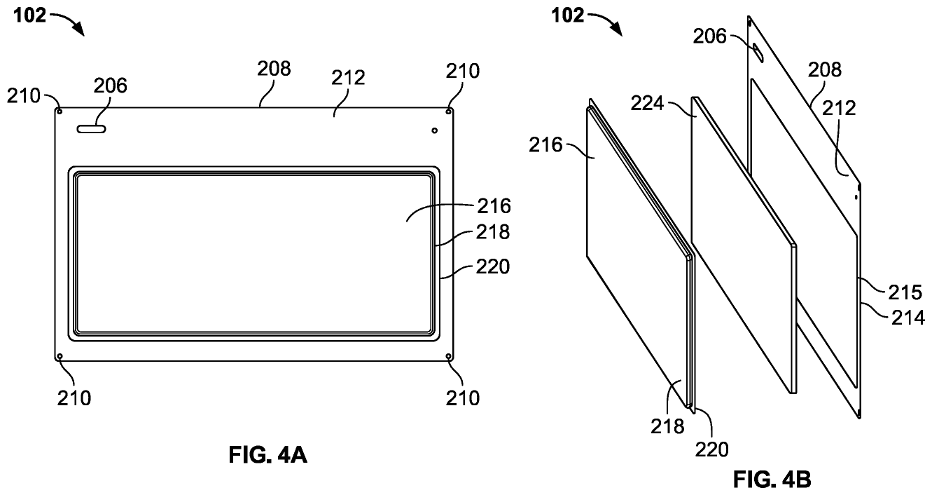

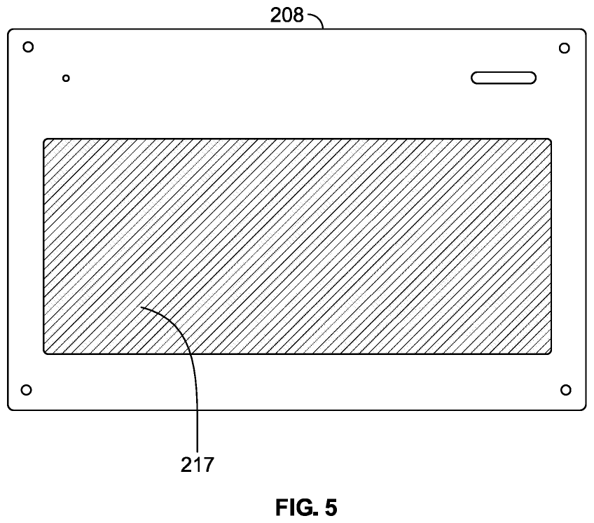

Referring to FIGS. 1-15, in one aspect a static (non-flowing) bipolar zinc-halide rechargeable electrochemical cell 100 and battery stacks of such cells 1000 is described.

A. Bipolar Electrochemical Cell

The bipolar electrochemical cell 100 comprises a bipolar electrode 102, a terminal assembly 104, and a zinc-halide electrolyte.

1. Bipolar Electrodes

Bipolar electrodes 102, 102′ may comprise a bipolar electrode plate 208 having a front surface 212 and a back surface 214. One of the surfaces is the cathode surface and the other is the anode surface. A cathode assembly 202 including a cathode substrate 224 is affixed to a cathode surface, such as the front surface, of the bipolar electrode plate so that the cathode assembly electrically communicates with at least that surface (e.g., the front surface) of the bipolar electrode plate 208. Bipolar electrodes 102 may be configured to plate zinc metal on an anodic electrode surface (e.g., the back surface of an adjacent bipolar electrode or an inner surface of an endplate of a terminal anode assembly) and generate halide or mixed halide species during charging of the electrochemical cell that are reversibly sequestered in the cathode assembly. Conversely, these electrodes are configured to oxidize plated zinc metal to generate Zn²⁺ cations and reduce the halide or mixed halide species to their corresponding anions during discharging of the electrochemical cell.

a. Bipolar Electrode Plates

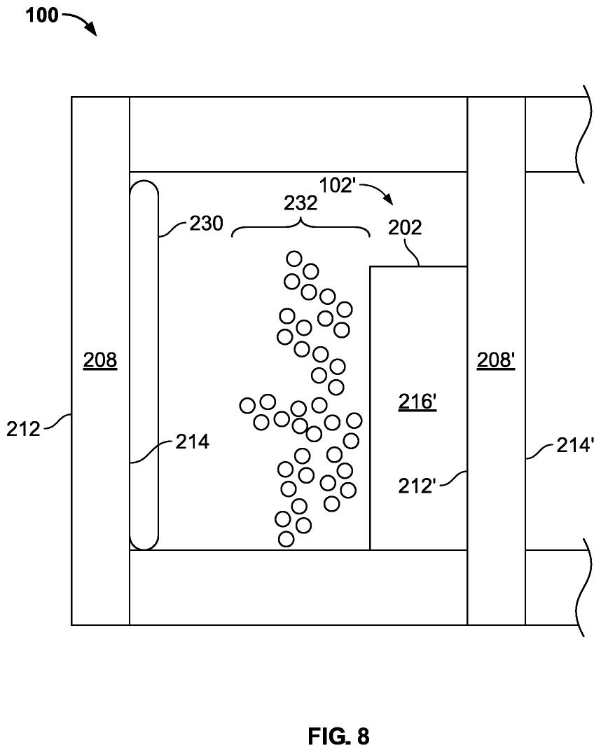

Bipolar electrode plates 208, 208′ may comprise a front surface 212 (212′) and a back surface 214 (214′), as illustrated for example, in FIG. 8. In some embodiments, the front surface 212 is a cathode surface and the back surface 214 is an anode surface (of zinc anode 230). The cathode assembly is situated on the cathode surface (e.g., the front surface 212) of the bipolar electrode plate 208. The bipolar electrode plate comprises a conductive coating or a film that is relatively inert to the zinc halide electrolyte used in the electrochemical cell or battery stack. In some embodiments, the conductive coating or film covers at least a portion of the bipolar electrode plate 208, such as at least a portion of the front surface 212, at least a portion of the back surface 214, or at least a portion of both surfaces.

In some embodiments, the bipolar electrode plate 208 comprises titanium, titanium oxide, TiC, TiN, graphite, or an electrically conductive plastic. In some embodiments, the bipolar electrode plate 208 comprises a titanium material. In some embodiments, the bipolar electrode plate 208 comprises a titanium material that is at least partially coated with a titanium carbide material. In some embodiments, bipolar electrode plate 208 comprises a titanium material that is thermally diffused with carbon. In these embodiments, at least a portion of the front surface 212, at least a portion of the back surface 214, or at least a portion of both surfaces are coated with the titanium carbide material or thermally diffused with carbon. In some embodiments, the bipolar electrode plate 208 comprises an electrically conductive carbon material, such as a graphite plate. In some embodiments, the bipolar electrode plate 208 comprises a graphite plate that is coated with a titanium carbide material. In these embodiments, at least a portion of the front surface 212, the back surface 214, or at least a portion of either of these surfaces is coated with the titanium carbide material. In some embodiments, the bipolar electrode plate 208 comprises an electrically conductive plastic. Any suitable electrically conductive plastic may be used within the scope of what is described. Such electrically conductive plastic material may comprise a base resin polymer with carbon black, graphite, fumed silica, or combinations thereof. For example, electrically conductive plastics described in U.S. Pat. No. 4,169,816, filed Mar. 6, 1978, which is incorporated herein by reference, may be used within the scope of what is described herein.

The bipolar electrode plate described herein optionally comprises a recessed portion 215 on the front surface 212 of the bipolar electrode plate. In some embodiments, the bipolar electrode plate comprises a recessed portion 215 on the front surface 212 of the bipolar electrode plate. In some of these embodiments, peripheral edges of the recessed portion 215 are substantially defined by the outermost edge of the flange 220 of the cathode cage 216 of the cathode assembly 202, such that the cathode assembly at least partially fits within recessed portion 215 when the bipolar electrode is assembled. In other embodiments, the peripheral edges of the recessed portion are at least partially within the outermost edge of the flange 220 of the cathode cage 216 of the cathode assembly 202. In some of these embodiments, the recessed portion may be defined by the outermost edge of the loaded carbon felt 224 that is nested within the cathode cage 216 of the cathode assembly 202, such that the loaded carbon felt 224 at least partially fits within recessed portion 215 of the bipolar electrode plate when the bipolar electrode 102 is assembled. And, in some alternative embodiments, the front surface 212 of the bipolar electrode plate lacks a recessed portion such that the surface is at least substantially flat.

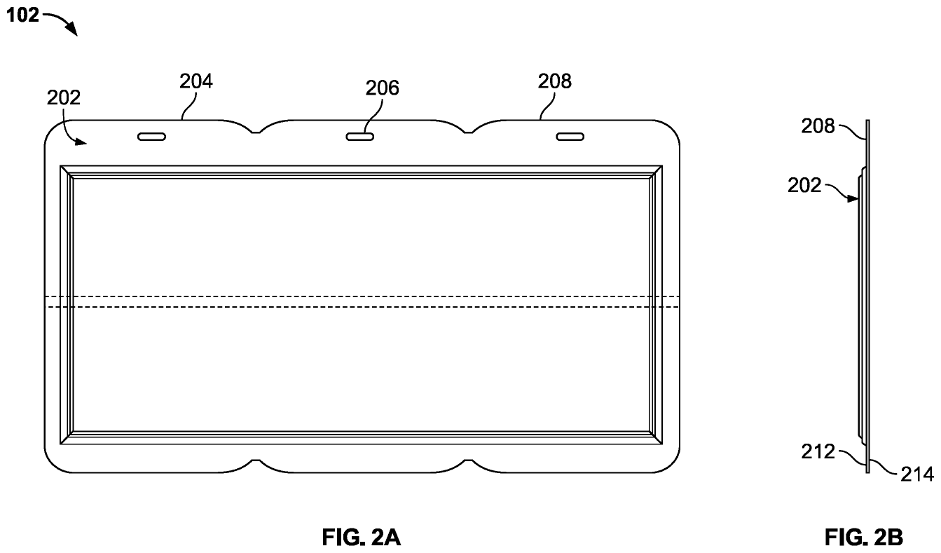

Bipolar electrode plates as described may optionally comprise one or more thru holes at or near the periphery 204 of the plate. Referring to FIGS. 2A-4B, in some embodiments, the bipolar electrode plate comprises one or more thru holes 206, 210 at or near the periphery 204 of the plate that may be useful for filling an electrochemical cell with liquid electrolyte or may be useful for aligning electrode plates in battery stacks.

The bipolar electrode plates may be formed by stamping or other suitable processes. A portion of the front surface 212, a portion of the back surface 214, or portions of both surfaces may optionally undergo surface treatments (e.g., coating or the like) to enhance the electrochemical properties of the cell or battery stack. The back surface of the bipolar electrode plate may include an electrochemically active region associated with or defined by the formation of a layer of zinc metal upon cell or battery stack charging. In some embodiments, the back surface of the electrode plate may be sandblasted (e.g., sandblasted with SiC or garnet), textured, or otherwise treated within the electrochemically active region. In other embodiments, the front surface may also be sandblasted within an electrochemically active region associated with a region enclosed by the cathode assembly.

For example, in some embodiments, at least a portion of the back surface, at least a portion of the front surface, or at least portions of both surfaces are treated (e.g., sandblasted) to give a rough surface. In some instances, at least a portion of the back surface of the bipolar electrode plate is treated (e.g., sandblasted) to give a rough surface. In some instances, the region of the back surface that is treated to give a rough surface is substantially defined by the periphery of the cathode assembly affixed to the front surface of the electrode plate.

In some embodiments, the electrochemical cell comprises a semipermeable barrier disposed between the anode surface and the cathode surface. In some embodiments, the electrochemical cell does not comprise a semipermeable barrier disposed between the anode surface and the cathode surface.

b. Cathode Assemblies

Electrochemical cells and battery stacks as described may comprise at least one cathode assembly 202. The cathode assembly 202 is situated on the cathode surface (e.g., the front surface 212) of the bipolar electrode plate 208, wherein the cathode assembly 202 comprises at least one cathode substrate 224. The cathode surface at least partially contacts the cathode substrate 224. An adhesive, a glue, an electrically conductive bonding material, a tape, a mechanical cage, or combination thereof electrically connects the cathode substrate 224 to the cathode surface of the bipolar electrode plate 208. In some embodiments, the mechanical cage is a cathode cage.

i.a. Cathode Cage

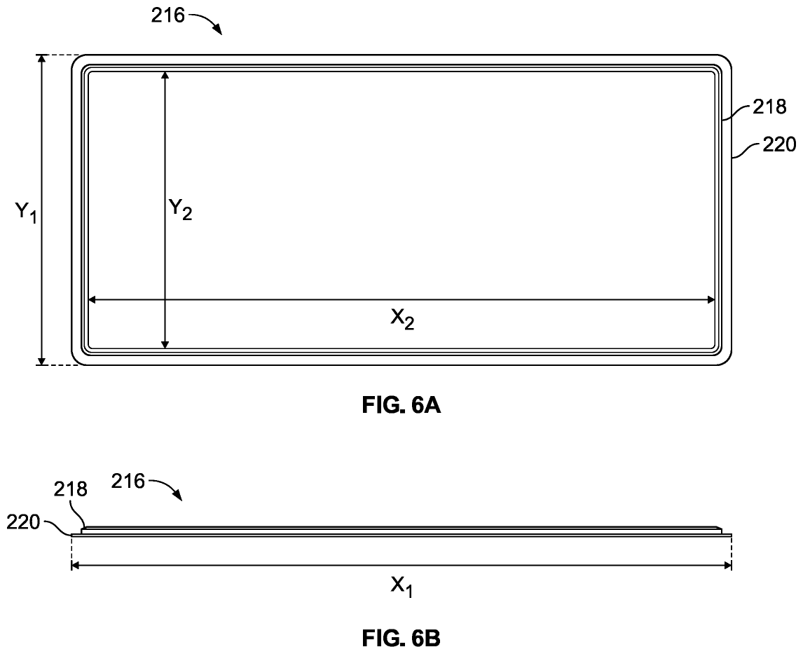

The mechanical cage, such as the cathode cage 216, comprises a pocket portion 218 and a flange 220 and is disposed on either the front surface 212, 212′ of the bipolar electrode plate or the inner surface 316 of a terminal endplate at the flange 220. Referring to FIGS. 6A and 6B, a front view (FIG. 6A) and a side view (FIG. 6B) of the cathode cage 216 are illustrated. The cathode cage 216 includes an overall area defined by the length X₁ and the width Y₁ that includes the flange 220. To form the flanges, a flat metal sheet is installed in a forming machine to press the flanges on each of the four edges of the flat sheet. In some implementations, the flat metal sheet comprises a titanium or titanium carbide material. In some embodiments, the cathode cage further comprises slots at the corners of the cage. These slots may be formed by laser cutting. The cathode cage 216 includes a reduced area corresponding to the pocket portion 218 defined by the length X₂ and the width Y₂. Accordingly, X₁ is greater than X₂ and Y₁ is greater than Y₂. In the example shown, the flange 220 is flexed flat relative to the pocket portion 218 to dictate the X₁/X₂ and Y₁/Y₂ dimensions and the depth of the pocket portion. In some embodiments, the area defined by X₂ and Y₂ is indicative of the etching area where a plurality of holes 227 are formed. Lengths X₁/X₂ and widths Y₁/Y₂ may vary based upon the operating requirements of the electrochemical cell 100 or battery stack 1000.

In some embodiments, the flange 220 includes a surface adjacent to and contacting the front surface 212 of the bipolar electrode plate and a depth of the pocket portion 218 extends from the flange in a direction away from the front surface of the electrode plate. The pocket portion 218 of the cathode cage operates cooperatively with the front surface of the electrode plate to form a chamber in which the loaded carbon felt 224 is situated. In some of these embodiments, the cathode cage is disposed on the front surface of the electrode plate at its flange by welding, use of an adhesive, an electrically conductive bonding material, use of a mechanical fastener, or any combination thereof.

The cathode cage is formed of a metal, metal alloy, or plastic that is substantially inert to the electrolyte of the electrochemical cell or battery stack. In some embodiments, the cathode cage is stamped from a titanium material. In some embodiments, the cathode cage comprises titanium or titanium oxide. In some embodiments, the cathode cage comprises a titanium material that is coated with a titanium carbide material.

In some embodiments, the pocket portion of the cathode cage is chemically-etched to form a plurality of spaced holes 227. In some embodiments, the holes are sized and spaced to form a hole pattern (e.g., a modulated hole pattern) that increases the uniformity of current and/or charge distributed across the cathode cage by compensating for the deformation or bending of the pocket portion of the cathode cage that occurs during operation (e.g., charging or discharging) of the electrochemical cell.

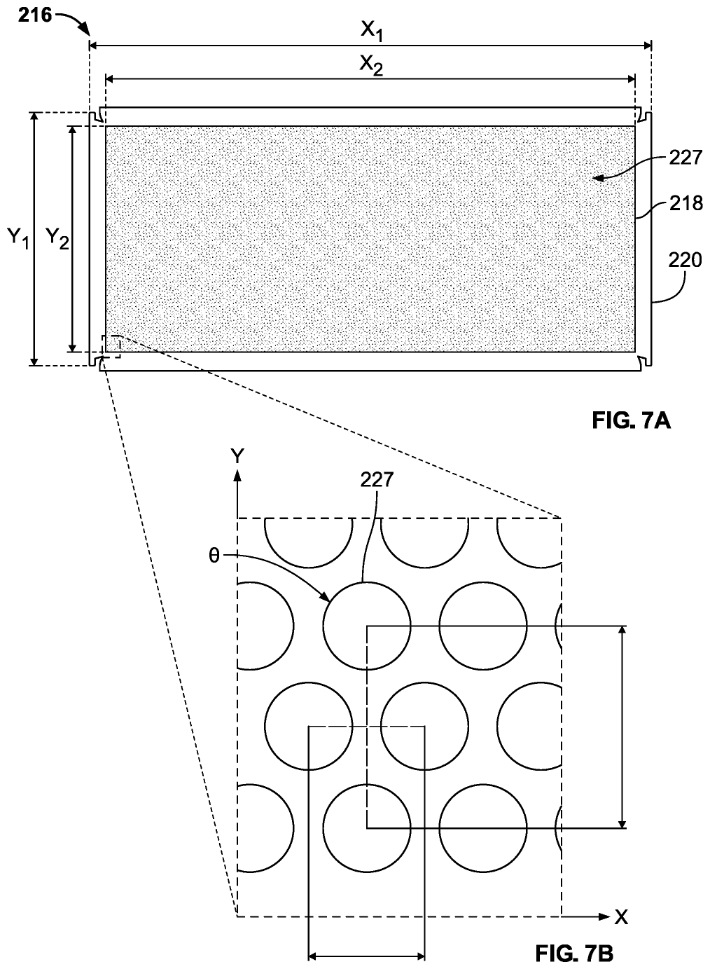

FIG. 7A illustrates the front view of the cathode cage 216 depicted by FIG. 6A, including the plurality of holes 227 formed through the chemically-etched surface of the pocket portion 218 by chemical etching. FIG. 7B is a detailed view of a portion illustrated by FIG. 7A showing a distribution of the plurality of holes 227. The chemical etching process is a subtractive manufacturing process that eliminates solid material that is to be removed for forming the plurality of holes 227. During the first step of the chemical etching process, the cathode cage 216 begins as a flat metal sheet that is cut using a shear to achieve dimensions corresponding to X₁ and Y₁. Next, the metal sheet may be cleaned and coated with a dry film solder mask in a hot roll laminator and then cooled in a dark environment. A protective film may then be applied within a vacuum exposure unit to expose the metal sheet. In some examples, the magnitude of exposure may be measured using a step indicator, and the exposure is determined when a desired magnitude of exposure is achieved. Subsequently, the metal sheet is run through a developer to remove the protective film while a resolve detergent in the developer is applied to the metal sheet to remove unwanted, unexposed resist. The metal sheet may then be placed in a furnace rack and baked at a predetermined temperature for a predetermined period of time. For instance, the baking temperature may be about 250° F. for about 60 minutes. Following the baking cycle, each metal sheet is air-cooled, and a chemical etching device is programmed for specifications of the desired etching area, e.g., the area defined by X₂ and Y₂, and the baked and cooled metal sheet is run through the chemical etching device to remove the unwanted material and thereby form the holes 227.

Referring now to FIG. 7B, the plurality of holes 227 are spaced and distributed along rows in a pattern. In some embodiments, the pattern is an alternating repeating pattern. In some embodiments, the pattern is selected to permit a uniform distribution of current across the cathode cage 216 in the presence of the cathode cage bending and deforming from flat during charging of the electrochemical cell or battery stack. Providing the cathode cage with a hole pattern in accordance with the present disclosure enhances the uniform distribution of charge and/or current which generates a more uniform plating of zinc metal at the anodic surface (e.g., the back surface 214 of a bipolar electrode plate, or the inner surface 318 of an endplate, or both surfaces) of the bipolar electrode plate during charge cycles. Likewise, conversions between bromine and bromide anions at or near the cathode cage 216 may also be enhanced. In some embodiments, the spacing between each hole of the plurality of holes 227 along the rows in the x-direction, the spacing between the alternating rows in the y-direction, and the diameter, f, of the holes may be selected to achieve a substantially uniform distribution of charge and/or current across the cathode cage 216 based on the amount of bend or deformation that results in the cathode cage and the bipolar electrode the when the electrochemical cell or battery stack undergoes charging and discharging. In some implementations, the distribution of the x and y hole locations (e.g., spacing) in each of the x and y directions is based upon a nominal hole area and a recommended web length of the cathode cage 216. The thickness of the surface of the pocket portion 218 may dictate the dimensions of the nominal hole area and the recommended web length. In some examples, the center of the adjacent plurality of holes 227 along a row are spaced by about 0.067 cm in the x-direction and every other row is spaced by about 0.152 cm in the y-direction. As described in greater detail below, the cathode cage 216, and the bipolar electrode plate 208, 208′, or the terminal endplate 302 will bend greater distances from flat at regions further from the perimeter at each of the parts resulting in the spacing between the anode and cathode electrodes to be shorter at the center regions with respect the outer regions near the perimeter. Generally, as the spacing between the anode and cathode electrodes decreases, the calculated hole diameter at corresponding x and y hole locations will increase.

i.b. Adhesive, Glue, an Electrically Conductive Bonding Material, and/or Tape

In addition to the cathode cage, or instead of a cathode cage, an adhesive, glue, an electrically conductive bonding material, and/or a tape may be applied to the bipolar electrode plate and used to hold the cathode substrate at least partially in contact with the bipolar electrode plate. The cathode cage, adhesive, glue, bonding material, or tape is electrically conductive. In some embodiments, the bipolar electrode and electrochemical cell are constructed, without a cathode cage, using adhesive to attach the loaded carbon felt to the cathode side of the bipolar electrode plate. The electrochemical cell lacks any graphite plates that are in electrical communication with the cathode side of the bipolar plate.

As discussed above, below and throughout, an adhesive may be used to attach the cathode substrate to the bipolar electrode plate. In some embodiments, a volume (e.g., 5 ml) of the adhesive or glue is applied to the cathode surface of the bipolar electrode and the cathode substrate is placed on top of the adhesive and pressure (e.g., 3 psi, 5 psi, or the like) is applied to the top of the carbon substrate and the adhesive or glue is then dried (e.g., for 1 hour). The adhesive may then hold the cathode substrate on the face of the bipolar electrode plate. The cathode substrate may have a substantially rectangular shape and may be approximately centered and aligned with a substantially rectangular bipolar electrode plate. In some embodiments, a tape can be used instead or in addition to an adhesive or glue.

One exemplary adhesive or glue that may be used to hold the carbon felt in contact with the bipolar electrode plate is an adhesive or a glue comprising a mixture of acetone, polyvinylidene fluoride, methyl mathacrylate/n-butyl methacrylate copolymer, and graphite. In some embodiments, the glue comprises from about 50 WL % to about 75 wt % acetone, from about 10 wt % to about 20 wt. % polyvinylidene fluoride, from about 5 wt % to about 10 wt. % methyl mathacrylate/n-butyl methacrylate copolymer, and from about 10 wt. % to about 20 wt. % graphite. For example, the adhesive or glue may comprise acetone, Kynar 2750, Elvacite 4111, and Timrex KS6 graphite.

ii. Cathode Substrate

The cathode substrate 224 is in electrical communication with the cathode surface of the bipolar electrode plate 208 and is adhered to the bipolar electrode plate 208 using an adhesive layer, glue, an electrically conductive bonding material, tape, or combination thereof. In some embodiments, the cathode substrate comprises carbon felt, graphite felt, packed carbon powder, graphite powder, expanded graphite powder, carbon foam, aerogel carbon, xerogel carbon, sol-gelated carbon, carbon cloth, carbon paper, or reticulated carbon.

In some embodiments, the cathode substrate comprises at least one carbon material. Carbon materials suitable for electrochemical cells as presently described may comprise any carbon material that can reversibly absorb aqueous bromine species (e.g., aqueous bromine or aqueous bromide) (collectively 702) and is substantially chemically inert in the presence of the electrolyte. In some embodiments, the carbon material comprises carbon blacks or other furnace process carbons. Suitable carbon black materials include, but are not limited to, Cabot Vulcan® XC72R, Akzo-Nobel Ketjenblack EC600JD, and other matte black mixtures of conductive furnace process carbon blacks. In some embodiments, the carbon material may also include other components, including but not limited to a PTFE binder and de-ionized water. For example, the carbon material has a water content of less than 50 wt. % (e.g., from about 0.01 wt. % to about 30 wt. %) by weight of the carbon material. In some embodiments, the carbon material comprises PTFE (e.g., from about 0.5 wt. % to about 5 wt. % by weight of the carbon material).

In some embodiments, the carbon material may be in the form of one or more thin rectangular blocks. In some embodiments, the carbon material may comprise a single solid block. In other embodiments, the carbon material may comprise from one to five, one to three, or one to two solid blocks of carbon blacks.

In some embodiments, the carbon material may be comprised of a woven carbon fiber or a non-woven carbon felt material.

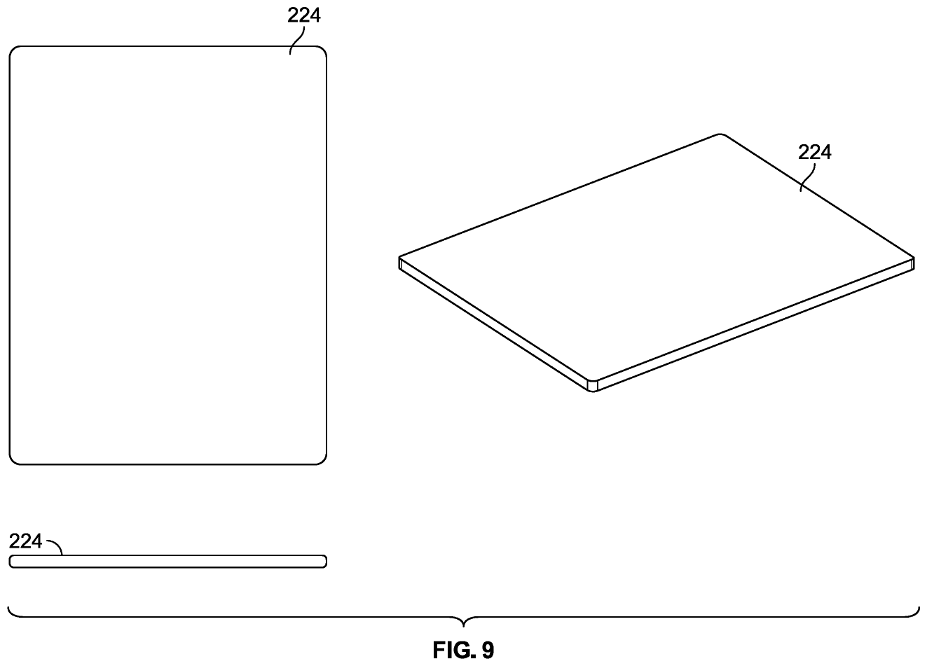

In some embodiments, the cathode substrate comprises carbon felt. FIG. 9 shows a front, side, and top perspective view of a loaded carbon felt for use as a cathode substrate according to an aspect of the devices described herein. The carbon felt 224 is in electrical communication with the front surface 212, 212′ of the bipolar electrode plate 208, 208′ and is confined by the cathode cage 216, 216′ and the front surface 212, 212′ of the bipolar electrode plate. In some embodiments, the carbon felt is made into a size and shape such that the loaded carbon felt can be at least partially nested by the cathode cage. In some embodiments, the carbon felt is made into a size and shape such that the loaded carbon felt can be at least partially nested by the frame. In some embodiments, the carbon felt is oxidized, carbonized, graphitized, activated, or any combination thereof. In some embodiments, the carbon felt has a thickness of from about 2 mm to about 10 mm. For example, the carbon felt may have a thickness of from about 4 mm to about 8 mm, from about 6 mm to about 10 mm, or from about 2 mm to about 6 mm. Without limitation, other carbon felt suitable for use in the presently described devices is commercially available from Avcarb, Cera Materials, or SGL Group (e.g., Avcarb G150, Avcarb G150A, Avcarb G200, Avcarb G200A, Avcarb G250, Avcarb G250A, Avcarb C1 50, Avcarb C200, Avcarb C250, Cera GFE-1, SGL GFA5, SGL GFA6, SGL KFD2.5, or SGL GFC4.6).

In some embodiments, the cathode substrate comprises packed carbon powder. In some embodiments, the carbon powder is activated carbon, carbon black, expanded graphite, graphite, or a combination of two or more thereof

2. Terminal Assembly

The bipolar electrochemical cell or battery as described herein further comprises a terminal assembly. A suitable terminal assembly may be, for example, the terminal assembly described in PCI Publication No. WO 2019/108513, filed Nov. 27, 2018, which is incorporated herein by reference, may be used within the scope of what is described herein.

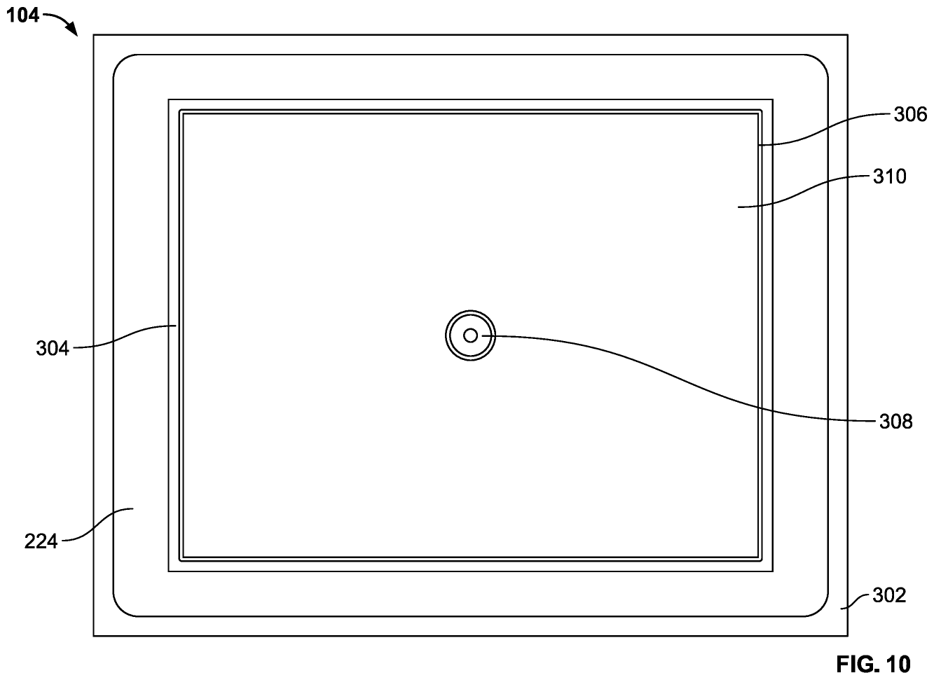

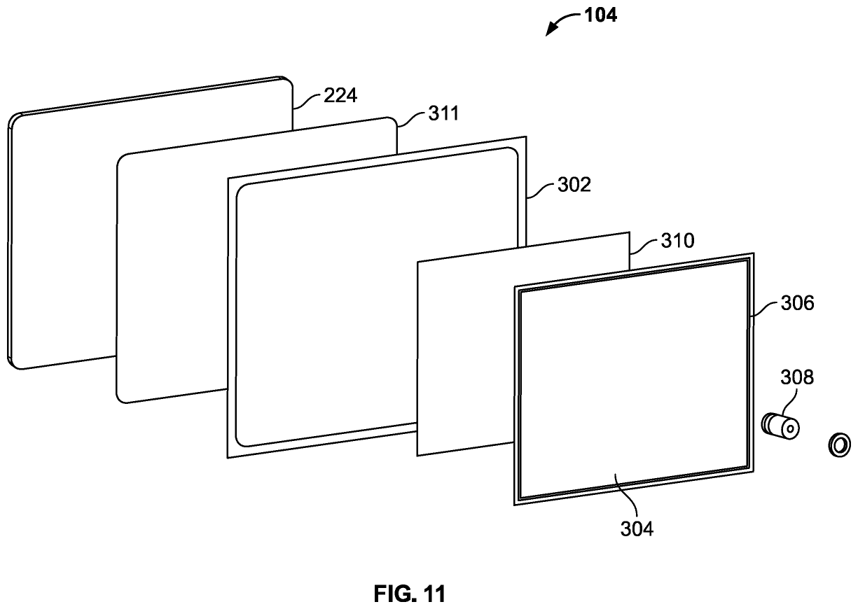

Referring to FIGS. 10-11, a terminal assembly 104 may comprise a terminal 308; a conductive flat-plate 304 with an electrically conducting perimeter 306; an electrically insulating tape member 310; and a terminal bipolar electrode plate 302. The conductive flat-plate 304, the terminal bipolar electrode plate 302 and the electrically insulating tape member 310 have inner and outer surfaces at least substantially parallel with each other, wherein the outer surface of the conductive flat-plate 304 is joined to the terminal 308, the inner surface of the conductive flat-plate 304 is joined to the outer surface of the terminal bipolar electrode plate 302, with the electrically insulating tape member 310 being in between the inner surface of the conductive flat-plate 304 and the outer surface of the terminal bipolar electrode plate 302 such that the electrically insulating tape member 310 does not cover the entire inner surface area of the conductive flat-plate 304, and wherein the electrically conducting perimeter 306 enables bi-directional uniform current flow through the conductive flat-plate 304 between the terminal 308 and the terminal bipolar electrode plate 302.

Since the insulating tape member 310 does not cover entire surface of the conductive flat-plate 304, it permits the electrically conducting perimeter 306 to be in electrical communication with the terminal bipolar electrode plate 302. In some embodiments, the dimensions of the insulating tape member 310 is smaller than the dimensions of the conductive flat-plate 304. The terminal 308 of the bipolar electrochemical battery is connected for electrical communication with the conductive flat-plate 304. In some embodiments, the outer surface of the conductive flat-plate 304 is joined to the terminal 308. In some embodiments, the terminal 308 comprises any electrically conducting material. In one embodiment, the terminal comprises brass (e.g., the terminal is a brass plug that electrically communicates or contacts the terminal perimeter).

The terminal bipolar electrode plate 302 of the terminal assembly 104 has inner and outer surfaces at least substantially parallel with the inner and outer surfaces of the conductive flat-plate 304 and electrically insulating tape member 310. The terminal bipolar electrode plate 302 may comprise, without limitation, a titanium material that is coated with a titanium carbide material, thru holes, rough inner surface, or the like. The electrically conducting perimeter 306 of the flat-plate 304 with electrically insulating tape member 310 joins to the bipolar electrode plate 302 such that the electrically conducting perimeter 306 is approximately centered about the electrochemically active region of the terminal bipolar electrode plate 302. In some embodiments, the electrochemically active region corresponds to a region extending between the inner and outer surfaces of the terminal bipolar electrode plate 302 in chemical or electrical communication with the adjacent terminal bipolar electrode plate during charge and discharge cycles of the electrochemical battery. In these embodiments, the electrochemically active region for the terminal bipolar electrode plate 302 associated with the cathode terminal of the battery corresponds to or is defined by an area enclosed by a cathode assembly disposed upon the inner surface of the terminal bipolar electrode plate 302 (e.g., the terminal cathode electrode plate). The electrochemically active region for the terminal bipolar electrode plate 302 associated with the anode terminal of the battery may correspond to an area on its inner surface that opposes a cathode assembly disposed on the front surface of an adjacent bipolar electrode plate and forms a layer of zinc metal upon charging of the battery (terminal anode assembly). In some embodiments, at least a portion of the surface (e.g., at least the chemically active region) of the terminal bipolar electrode plate 302 of the terminal anode assembly is a rough surface.

FIG. 11 provides an exploded view of the terminal assembly of FIG. 10 showing the cathode carbon material 224, the adhesive layer 311, the terminal bipolar electrode plate 302, the electrically insulating tape member 310, the conductive flat-plate 304, the electrically conducting perimeter 306, and the terminal 308.

In some embodiments, the electrically conducting perimeter 306 formed by welding is centered within the electrochemically active region of the terminal bipolar electrode plate 302. In some embodiments, the electrically conducting perimeter 306 is substantially rectangular, substantially circular or substantially elliptical. In some embodiments, the electrically conducting perimeter 306 is substantially rectangular.

In some embodiments, the conductive flat-plate 304 with electrically insulating tape member 310 is centered within the electrochemically active region of the terminal bipolar electrode plate 302.

In some embodiments, the surface of the electrically insulating tape member is joined to the surface of the conductive flat-plate by a weld or an adhesive. In some embodiments, the adhesive is electrically conductive.

The conductive flat-plate as described herein is larger than prior art current aggregators, and hence, it provides more contact points and better current density distribution. This reduces manufacturing costs.

In some embodiments, the terminal assembly is a terminal cathode assembly, wherein the terminal cathode assembly comprises a terminal bipolar electrode plate 302 having an electrochemically active region, a conductive flat-plate 304 with electrically insulating tape member 310 disposed on the surface of the terminal bipolar electrode plate 302 and approximately centered in the electrochemically active region, and a cathode assembly such as any of the cathode assemblies described herein disposed on the inner surface of the terminal bipolar electrode plate 302.

In some embodiments, the terminal assembly is a terminal anode assembly, wherein the terminal anode assembly comprises a terminal bipolar electrode plate 302 having an electrochemically active region, a conductive flat-plate 304 with electrically insulating tape member 310 centered in the electrochemically active region, and wherein the terminal anode assembly lacks a cathode assembly.

In some embodiments, the electrically conducting perimeter 306 of the conductive flat-plate 304 with electrically insulating tape member 310 is joined to the surface of the terminal bipolar electrode plate 302 by a weld or an adhesive. Non-limiting examples of a suitable welding process include spot welding, continuous welding, tungsten inert gas (TIG) welding, or resistance welding. In some instances, the adhesive is electrically conductive. Non-limiting examples of suitable electrically conductive adhesives include graphite filled adhesives (e.g., graphite filled epoxy, graphite filled silicone, graphite filled elastomer, or any combination thereof), nickel filled adhesives (e.g., nickel filled epoxy), silver filled adhesives (e.g., silver filled epoxy), copper filled adhesives (e.g., copper filled epoxy), any combination thereof, or the like.

In some embodiments, the conductive flat-plate 304 with electrically insulating tape member 310 is composed of at least one of a copper alloy, a copper/titanium clad, aluminum, titanium, and electrically conductive ceramics.

In some embodiments, at least one of the conductive flat-plate 304 with electrically insulating tape member 310 or the terminal bipolar electrode plate 302 comprises titanium. In some embodiments, at least one of the conductive flat-plate 304 with electrically insulating tape member 310 or the terminal bipolar electrode plate 302 comprises a titanium material coated with a titanium carbide material.

In some embodiments, the inner surfaces of at least one of the conductive flat-plate 304 with electrically insulating tape member 310 comprises copper.

In some embodiments, the outer surface of at least one of the conductive flat-plate 304 with electrically insulating tape member 310 comprises at least one of copper, titanium, and electrically conductive ceramics.

In some embodiments, the conductive flat-plate 304 with electrically insulating tape member 310 comprises a first metal and the terminal bipolar electrode plate 302 comprises a second metal.

In some embodiments, the electrically insulating tape member 310 may be comprised of any adhesive material that is electrically insulating in nature. Non-limiting examples of the electrically insulating tape member 310 include, for example, Kapton™, Mylar™, polyimide, polyethylene, nylon, Teflon, neoprene, or any other electrically insulating polymer.

3. Zinc-Halide Electrolyte

In electrochemical cells and battery stacks as described, an aqueous electrolyte, i.e., a zinc-halide electrolyte is interposed between the inner surface of the terminal endplate, the cathode assembly, the front surface of the bipolar electrode, and if present, the interior surfaces of the frame. In these embodiments, bromide anions at the surface of the cathode cage of the cathode assembly that is exposed to the electrolyte are oxidized to bromine when the electrochemical cell or battery stack is charging. Conversely, during discharge, the bromine is reduced to bromide anions. The conversion between bromine and bromide anions 232 at or near the cathode assembly can be expressed as follows:

Br₂+2e⁻→2Br⁻.

An aqueous electrolyte that is useful in flowing or non-flowing (i.e., static) rechargeable zinc halide electrochemical cells or battery stacks is described herein. In these cells or battery stacks, zinc bromide, zinc chloride, or any combination of the two, present in the electrolyte, acts as the electrochemically active material.

Any suitable zinc halide electrolyte may be used within the scope of what is described herein. For example, electrolytes described in PCT Publication No. WO 2016/057477, filed Oct. 6, 2015 and in US Application Publication No. 2017/0194666, filed Mar. 29, 2016, both of which are incorporated herein by reference, may be used within the scope of what is described herein.

One aspect of what is described herein contemplates an electrolyte for use in a secondary zinc bromine electrochemical cell comprising from about 30 wt. % to about 40 wt. % of ZnCl₂ or ZnBr₂; from about 5 wt. % to about 15 wt. % of KBr; from about 5 wt. % to about 15 wt. % of KCl; and one or more quaternary ammonium agents, wherein the electrolyte comprises from about 0.5 wt. % to about 10 wt. % of the one or more quaternary ammonium agents.

In some embodiments, the electrolyte comprises from about 4 wt. % to about 12 wt. % (e.g., from about 6 wt. % to about 10 wt. %) of potassium bromide (KBr). In some embodiments, the electrolyte comprises from about 8 wt. % to about 12 wt. % of potassium bromide (KBr).

In some embodiments, the electrolyte comprises from about 4 wt. % to about 12 wt. % (e.g., from about 6 wt. % to about 10 wt. %) of potassium chloride (KCl). In some embodiments, the electrolyte comprises from about 8 wt. % to about 14 wt. % of potassium chloride (KCl). In some embodiments, the electrolyte comprises from about 11 wt. % to about 14 wt. % of potassium chloride (KCl).

In some embodiments, the aqueous electrolyte comprises from about 25 wt. % to about 70 wt. % of ZnBr₂; from about 5 wt. % to about 50 wt. % of water; and from about 0.05 wt. % to about 10 wt. % of one or more quaternary ammonium agents.

In some embodiments, the aqueous electrolyte comprises from about 25 wt. % to about 40 wt. % of ZnBr₂; from about 25 wt. % to about 50 wt. % water; from about 5 wt. % to about 15 wt. % of KBr; from about 5 wt. % to about 15 wt. % of KCl; and from about 0.5 wt. % to about 10 wt. % of the one or more quaternary ammonium agents.

In some embodiments, the one or more quaternary ammonium agents comprises a quaternary agent selected from the group consisting of ammonium chloride, tetraethylammonium bromide, tetraethylammonium chloride, trimethylpropylammonium bromide, triethylmethyl ammonium chloride, trimethylpropylammonium chloride, butyltrimethylammonium chloride, trimethylethyl ammonium chloride, N-methyl-N-ethylmorpholinium bromide, N-methyl-N-ethylmorpholinium bromide (MEMBr), 1-ethyl-1-methylmorpholinium bromide, N-methyl-N-butylmorpholinium bromide, N-methyl-N-ethylpyrrolidinium bromide, N,N,N-triethyl-N-propylammonium bromide, N-ethyl-N-propylpyrrolidinium bromide, N-propyl-N-butylpyrrolidinium bromide, N-methyl-N-butylpyrrolidinium bromide, 1-methyl-1-butylpyrrolidinium bromide, N-ethyl-N-(2-chloroethyl)pyrrolidinium bromide, N-methyl-N-hexylpyrrolidinium bromide, N-methyl-N-pentylpyrrolidinium bromide, N-ethyl-N-pentylpyrrolidinium bromide, N-ethyl-N-butylpyrrolidinium bromide, trimethylene-bis(N-methylpyrrolidinium) dibromide, N-butyl-N-pentylpyrrolidinium bromide, N-methyl-N-propylpyrrolidinium bromide, N-propyl-N-pentylpyrrolidinium bromide, 1-ethyl-4-methylpyridinium bromide, 1-ethyl-2-methylpyridinium bromide, 1-butyl-3-methylpyridinium bromide, cetyltrimethylammonium bromide, cetyltrimethylammonium chloride, cetyltriethylammonium bromide, and any combination thereof.

In some embodiments, the one or more quaternary ammonium agents comprises an alkyl substituted pyridinium chloride, an alkyl substituted pyridinium bromide, an alkyl substituted morpholinium chloride, an alkyl substituted morpholinium bromide, an alkyl substituted pyrrolidinium chloride, an alkyl substituted pyrrolidinium bromide, or any combination thereof.

In some embodiments, the electrolyte comprises one or more additional components such as a glyme (e.g., monoglyme, diglyme, triglyme, tetraglyme, pentaglyme, hexaglyme, or any combination thereof), an ether (e.g., DME-PEG, dimethyl ether, or a combination thereof), an alcohol (e.g., methanol, ethanol, 1-propanol, isopropanol, 1-butanol, sec-butanol, iso-butanol, tert-butanol, or any combination thereof), a glycol (e.g., ethylene glycol, propylene glycol, 1,3-butylene glycol, 1,4-butylene glycol, neopentyl glycol, hexalene glycol, or any combination thereof), an additive (e.g., Sn, In, Ga, Al, Tl, Bi, Pb, Sb, Ag, Mn, Fe, or any combination thereof), an acid (e.g., acetic acid, nitric acid, citric acid, or any combination thereof), potassium dihydrogen citrate, a crown ether (e.g. 18-crown-6, 15-crown-5, or a combination thereof), citric acid monohydrate, or potassium dihydrogen citrate monohydrate.

In one embodiment, the electrolyte consists of zinc bromide, 27.42 wt. %; water, 44.34 wt. %; potassium bromide, 6.78 wt. %; potassium chloride, 9.83%; 2,5,8,11,14-pentaoxapentadecane, 2.58 wt. %; 4-ethyl-4-methylmorpholin-4-ium bromide, 1.03 wt. %; tetraethylammonium bromide, 2.03 wt. %; triethylmethylammonium chloride, 1.94 wt. %; methoxypolyethylene glycol MW 2000, 1.29 wt. %; methoxypolyethylene glycol MW 1000, 0.32 wt. %; 2,2-dimethyl-1,3-propanediol, 1.29 wt. %; 2-methylpropan-2-ol, 0.32 wt. %; hexadecyltrimethylammonium bromide, 0.06 wt. %; hydrobromic acid (to reach a pH of 3.6), 0.52 wt. %; 1,1-dioctadecyl-4,4′ bipyridinium dibromide, 0.25 wt. %; tin chloride, 7 ppm; and indium chloride, 7 ppm.

In one embodiment, the electrolyte consists of zinc bromide, 35.41 wt. %; water, 38.84 wt. %; potassium bromide, 5.54 wt. %; potassium chloride, 11.09 wt. %; triethylmethylammonium chloride, 5.8 wt. %; polyethyleneglycol dimethyl ether (MW 2000), 1.26 wt. %; polyethyleneglycol dimethyl ether (MW 1000), 0.35 wt. %; 2,2-dimethylpropane-1,3-diol, 1 wt. %; polydimethyl siloxane trimethylsiloxy terminated (MW 1250), 0.2 wt. %; indium chloride, 7 ppm; and tin chloride, 7 ppm.

B. Battery Stacks

The battery stack comprises a plurality of bipolar electrodes at least partially disposed in zinc-halide electrolyte and interposed between a cathode terminal assembly and an anode terminal assembly. The cathode terminal assembly, the anode terminal assembly, the zinc-halide electrolyte, and the bipolar electrodes include any embodiments described herein.

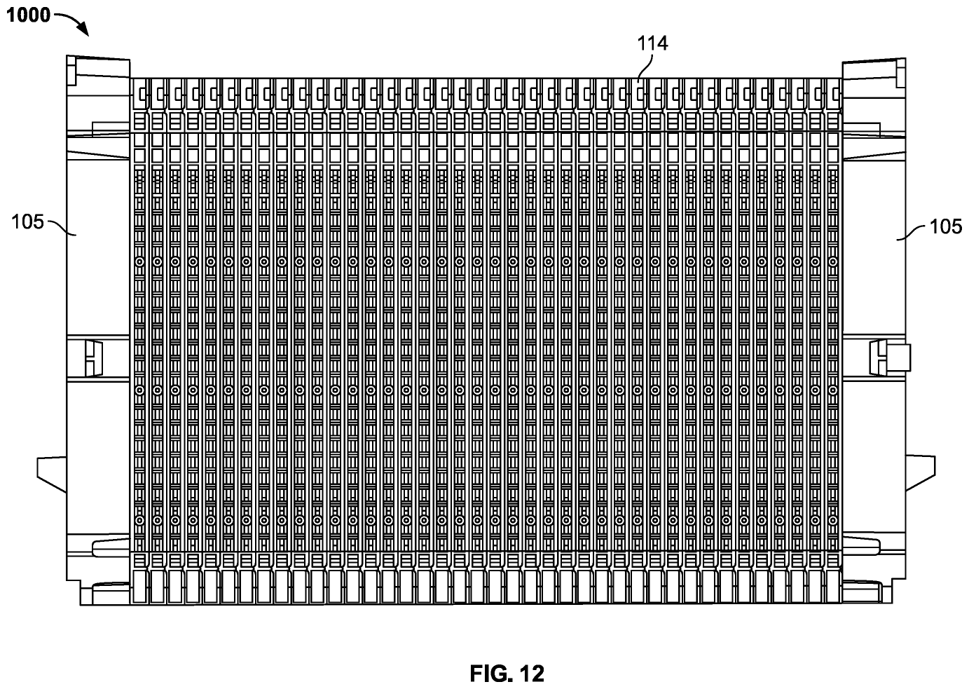

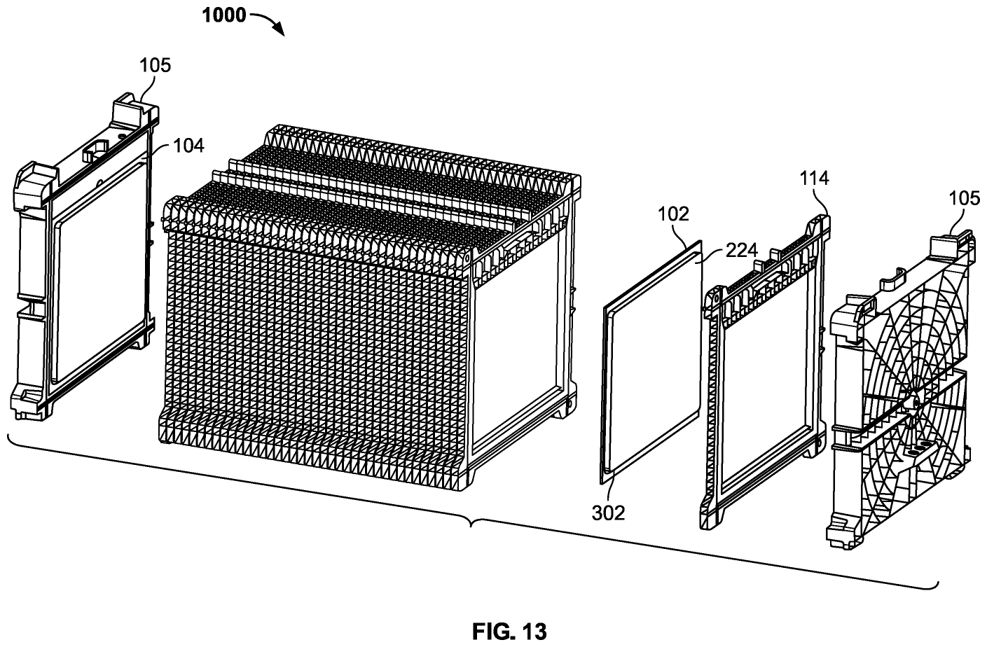

Referring to FIGS. 12 and 13, the battery stack 1000 comprises at least one bipolar electrochemical cell and two terminal electrochemical cells. In one embodiment, battery stack comprises 40 bipolar electrochemical cells in series and two terminal electrochemical cells.

The at least one bipolar electrochemical cell comprises a bipolar electrode 102, a battery frame member 114, and a zinc-halide electrolyte. The terminal electrochemical cell comprises a bipolar electrode 102, a battery frame member 114, a terminal assembly 104, a terminal endplate 105, and a zinc-halide electrolyte.

1. Frame Members

In some embodiments, the battery comprises a battery frame member 114 that is interposed between two adjacent bipolar electrodes or interposed between a bipolar electrode 102 and a terminal assembly 104 (e.g., a terminal anode assembly or a terminal cathode assembly).

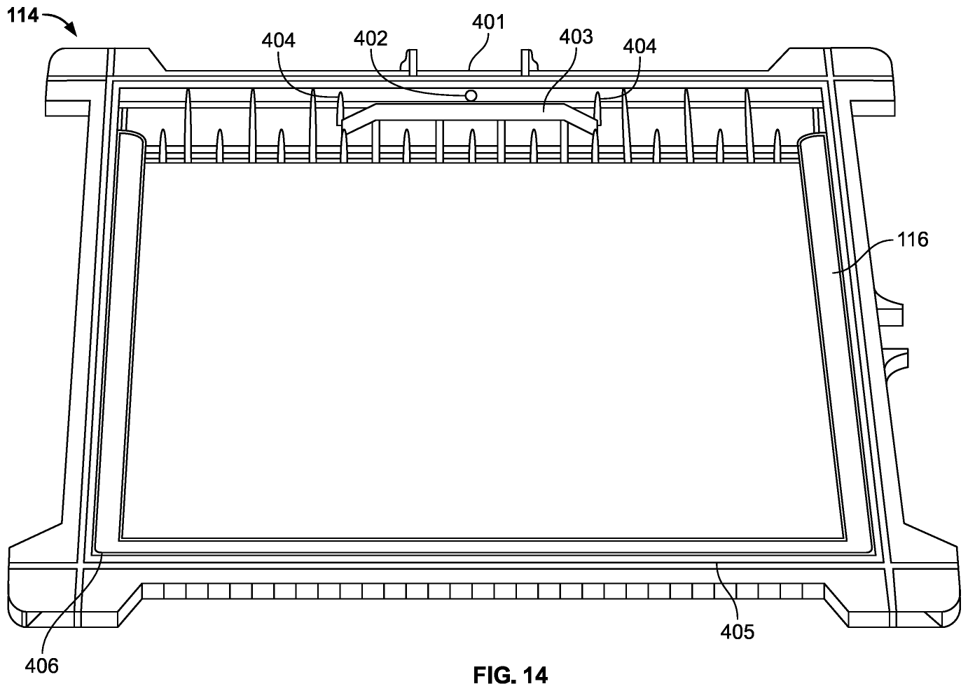

In one embodiment, illustrated in FIG. 14, the battery frame member 114 has an outer periphery edge, and an inner periphery edge defining an open interior region. In some embodiments, the battery frame member 114 is configured such that open interior region is approximately centered about the center of an electrochemically active region of a terminal bipolar electrode plate 302 received by the battery frame member 114 and/or the center of a cathode assembly disposed on a terminal bipolar electrode plate 302. In some embodiments, the outer periphery of the battery frame member 114 defines the outer surface of a battery.

In some embodiments, the battery frame member 114 includes a first side that opposes and retains the first terminal bipolar electrode plate 302 and a second side disposed on an opposite side of the battery frame member 114 than the first side that opposes and retains a second bipolar electrode plate. The second electrode plate is adjacent and parallel to the first electrode plate in the battery. The first and second electrode plates and the terminal electrode plate(s) may be configured to have substantially the same size and shape. In some embodiments, the battery frame member 114 is in contact with an anode bipolar electrode plate on one side and a cathode bipolar electrode plate of the adjacent bipolar cell on the other side.

In some embodiments, the battery frame member 114 includes a sealing member 116 (FIG. 14) that extends around the inner periphery edge. In some embodiments, the battery frame member 114 comprises a first sealing member 116 disposed along the first inner periphery edge. In some embodiments, the first sealing member is an O-ring. In some embodiments, the first sealing member 116 is a gasket. In some embodiments, each inner periphery edge is configured to receive a sealing member 116 seated therein that forms a substantially leak-free seal when the seal is compressed between the corresponding bipolar electrode plate or terminal electrode plate and the battery frame member 114 when the electrochemical battery is assembled to provide a sealing interface between the bipolar electrode plate or endplate and the battery frame member 114. The sealing members cooperate to retain the electrolyte between the opposing bipolar electrode plates and a battery frame member 114, or between a bipolar electrode plate, a terminal electrode plate and a frame member 114.

In some embodiments, the battery frame member 114 comprises a gutter in the bottom portion of the battery frame member 114 to prevent voltage anomalies during cycling. In some embodiments, the gutter comprises a gutter shelf 406 and a void space 407 underneath the gutter shelf 406. In some embodiments, the cathode carbon material 224 rests on the gutter shelf 406. It has been found that the presence of the gutter shelf and the void underneath the gutter shelf prevent voltage anomalies during cycling. In some embodiments, there is no void space 407 underneath the gutter shelf 406 and the gutter shelf 406 extends to the bottom of the battery frame member 114. In some embodiments, the gutter shelf 406, upon which the cathode carbon material 224 rests may be between 0.5 and 5 cm tall, including void space 407 under gutter shelf 406, and may be between 3 and 10 mm wide along the entire bottom portion of the battery frame member 114 width.

In some embodiments, the battery frame member comprises a first frame member and a second frame member. In some embodiments, the first frame member and the second frame member are horizontally stacked and vertically oriented, wherein a first outer edge of the first frame member is substantially coplanar with a second outer edge of the second frame member.

In some embodiments of a battery, each battery frame member 114 is plastic welded to the adjacent frame member 114 using a weld bead 405 around the perimeter of the battery frame member 114.

In some embodiments, a liquid diversion system exists in the top of the battery frame member 114 directly below a ventilation hole 402 which allows gas to escape into a gas channel 401. In some embodiments, the liquid diversion system comprises a primary diverter feature 403 with two partial blocking walls 404 and multiple secondary blocking walls ensuring liquid always is directed back to the open interior region within the battery frame member 114. In some embodiments, the primary diverter 403 consists of a horizontal plastic protrusion with end pieces facing downward with an angle ranging from 30 to 60 degrees. In some embodiments, secondary blocking walls ensure minimum fluid will reach the primary diverter. One of the advantages of the liquid diversion system is that it improves quality of the battery by keeping electrolyte contained within frame member during transportation.

Each battery frame member 114 may be formed from flame retardant polypropylene fibers, high density polyethylene, polyphenylene oxide, or polyphenylene ether. Each battery frame member 114 may receive two adjacent bipolar electrode plates or a bipolar electrode plate and a terminal electrode plate. Each battery frame member 114 may also house an aqueous electrolyte solution (e.g., zinc-halide electrolyte or zinc-bromide electrolyte).

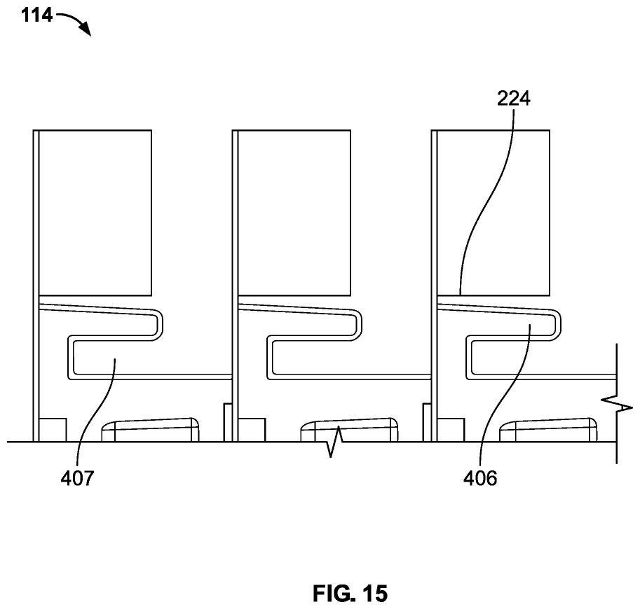

FIG. 15 shows a close-up side-view of the bottom portion of the battery frame member 114 showing the gutter shelf 406 and the void space 407 under the gutter shelf in this embodiment, each frame member within the battery contains the gutter shelf 406 and void space 407.

2. Compression Plates

In some embodiments, the electrochemical cell or battery stack comprises a pair of compression plates located at the ends of the electrochemical cell or battery stack. Suitable compression plates may be, for example, the compression plates described in PCT Publication No. WO 2019/108513, filed Nov. 27, 2018, which is incorporated herein by reference, may be used within the scope of what is described herein.

### III. BIPOLAR ELECTRODE COMPRISING A CATHODE SURFACE WITH A HALOGEN COMPLEXING AGENT

A. Cathode Substrate with a Halogen Complexing Agent

As discussed above, an optimal cathode surface for a zinc bromine battery should display rapid bromine redox kinetics, a high degree of bromine complex retention, low electrical resistance and high chemical stability. However, current zinc bromine batteries rely on physical trapping of the bromine or polybromide in the porous cathode substrate, which is difficult when concentration gradients and density gradients can cause movement of the bromine and polybromides away from the cathode, rendering them unavailable during discharge. Polybromides tend to accumulate at the bottom of the cathode substrate reducing the surface area of the cathode substrate that can be utilized during discharge. Some of the polybromide oil phase is lost entirely from the cathode substrate, meaning that it can come into contact with the anode and increase the rate of self-discharge.

The inventors of the present application have unexpectedly found that a bipolar electrode with a cathode substrate loaded with a halogen complexing agent as described herein can improve the bromine retention and spatial distribution of capacity in the cathode surface. A method of chemically bonding the bromine and polybromides to the cathode surface, which anchors the bromine and polybromide in one location is described herein. Without being bound by theory, it is hypothesized that the halogen complexing agents are chemically bonded to the cathode substrate by taking advantage of oxygen functional groups on the cathode substrate. The halogen complexing agents are then available to complex bromine and polybromides and keep these materials anchored/bound to the cathode substrate surface. This approach is advantageous in that (1) it allows for a wide range of chemistry choices for introducing halogen complexing agent bound onto the cathode substrate; (2) it only covers a fraction of the cathode substrate with functional groups of the halogen complexing agent such that reaction sites on the cathode substrate are not compromised; (3) this approach is an easy and cost effective method of treating a vast majority of cathode substrates including carbon felt, graphite felt, packed carbon powder, graphite powder, expanded graphite powder, carbon foam, aerogel carbon, xerogel carbon, sol-gelated carbon, carbon cloth, carbon paper, and reticulated carbon; and (4) this approach can easily be scaled up to large scale manufacturing and large format electrodes for commercial application.

One aspect of what is described herein relates to a bipolar electrode comprising: a bipolar electrode plate having a cathode surface and an anode surface, wherein the cathode surface opposes the anode surface; and a cathode substrate loaded with a halogen complexing agent, wherein the cathode surface at least partially contacts the cathode substrate. The halogen complexing agent has a structure of Formula (I): Q⁺(R^{A})(R^{B})(R^{C})(R^{D})X⁻, wherein:
Q is N, P, or S;
R^{A}, R^{B}, and R^{C} are each independently hydrogen or optionally substituted branched or unbranched C₁ to C₂₀ alkyl, allyl, or vinyl, or any two of R^{A-C} join with Q to form a C₃ to C₆ cyclic group optionally comprising one or more additional heteroatoms selected from N, P, and O;
R^{D} is optionally substituted branched or unbranched C₁ to C₂₀ alkyl, allyl, vinyl, or C₃ to C₆ cyclic group optionally comprising one or more heteroatoms selected from N, P, and O, wherein R^{D} has a terminal functional group;
X⁻ is F⁻, Cl⁻, Br⁻, or I⁻,
wherein the functional group is —PO₃H₂, —Si(R^{E})(R^{F})(R^{G}), or —C(R^{H})(R^{I})Y,
wherein:
R^{E}, R^{F}, and R^{G} are each independently OCH₃, OCH₂CH₃, CH₃, or Cl,
R^{H} and R^{I} are each independently H or C₁ to C₂₀ alkyl,
Y is a halide.

In one embodiment, R^{A}, R^{B}, R^{C}, and R^{D} groups are each independently optionally substituted by halide, hydroxy, carboxylic acid, ether, amine, amide, or ammonium. Non-limiting examples of each of the R^{A}, R^{B}, and R^{C} groups include, e.g., optionally substituted methyl, ethyl, propyl, butyl, pentyl, hexyl, dodecyl, octadecyl, ethenyl, 2-propenyl, ethynyl, 2-propynyl, pyridinium (C₅H₅N⁺—), piperidinium (C₅H₁₂(R)N⁺), pyrrolidinium (C₄H₈N⁺—), or imidazolium(C₃H₃N(R)N⁺—).

The R^{D} group is optionally substituted branched or unbranched C₁ to C₂₀ alkyl, allyl, vinyl, or C₃ to C₆ cyclic group optionally comprising one or more heteroatoms selected from N, P, and O, wherein R^{D} has a terminal functional group. Non-limiting examples of the R^{D} group include, e.g., optionally substituted methyl, ethyl, propyl, butyl, pentyl, hexyl, dodecyl, octadecyl, ethenyl, 2-propenyl, ethynyl, 2-propynyl, pyridinium (C₅H₅N⁺—), piperidinium (C₅H₁₂N⁺—), pyrrolidinium (C₄H₈N⁻—), or imidazolium(C₃H₃N(R)N⁺—), with a terminal functional group. In some embodiments, the terminal functional group is a phosphonic acid group, a silyl ether group, or an alkyl halide group.

The halogen complexing agent is introduced to the cathode substrate as a monomer. In some embodiments, the halogen complexing agent does not comprise a polymer. The halogen complexing agent forms a self-assembled monolayer or multilayer that coats the surface of the cathode substrate. In some embodiments, the cathode substrate is chemically bonded with a monomer of the halogen complexing agent. In some embodiments, the cathode substrate is chemically bonded with a polymer of the halogen complexing agent. The formed monolayer or multilayer film is so thin that it does not significantly increase the resistance of the cell, reduce the electrochemically active surface area of the electrode, or prevent the flow transport of electrolyte components through the electrode like other doping methods might. Other methods involving physical entrapment of halogen complexing agents within the cathode substrate, for example by using polymer or crosslinked polymer complexing agents, may impede the transport of electrolyte components throughout the electrode or cover substantial portion of the electrode surface rendering it electrochemically inactive.

In some embodiments, the halogen complexing agent is a quaternary ammonium halide, a phosphonium halide, or a sulfonium halide. In one embodiment, the halogen complexing agent is a quaternary ammonium halide. It should be noted that quaternary ammonium salts commonly used in the electrolyte will not adhere strongly to the cathode substrate because no ionic or covalent interaction can be formed between such quaternary ammonium salts and the cathode substrate. If the cathode is loaded with quaternary ammonium salts that lack the ability to bind to the cathode substrate, then, due to the positive charge on the ammonium group, they are likely to migrate away from the cathode towards the anode during cycling of the battery. This would reduce the availability of bromine and polybromides in the cathode during discharge. In contrast, by using the halogen complexing agent described herein (including, for example, the quaternary ammonium salts of Formula (I)), in which one of the side chains (i.e., the R^{D} group) is terminated in a functional group that can covalently bond to the surface of the cathode substrate, it is possible to coat the surface of the cathode substrate with a layer of the halogen complexing agent that will adhere strongly and resist diffusion into the bulk electrolyte.

Non-limiting examples of the halogen complexing agent, include, e.g., (12-dodecylphosphonic acid)triethylammonium bromide, trimethyl[3-(trimethoxy silyl)propyl]ammonium chloride, N-trimethoxysilylproply-N,N,N-tri-n-butylammonium bromide, N-trimethoxysilylundecyl-N,N,N-tri-n-butylammonium bromide, (12-Dodecylphosphonic acid)triethylammonium chloride, (12-Dodecylphosphonic acid)pyridinium bromide, (12-Dodecylphosphonic acid)N,N-Dimethyl-N-octadecyl ammonium bromide, 1-Methyl-3-(dodecylphosphonic acid)imidazolium bromide, or 1-Methyl-3-(hexylphosphonic acid)imidazolium bromide.

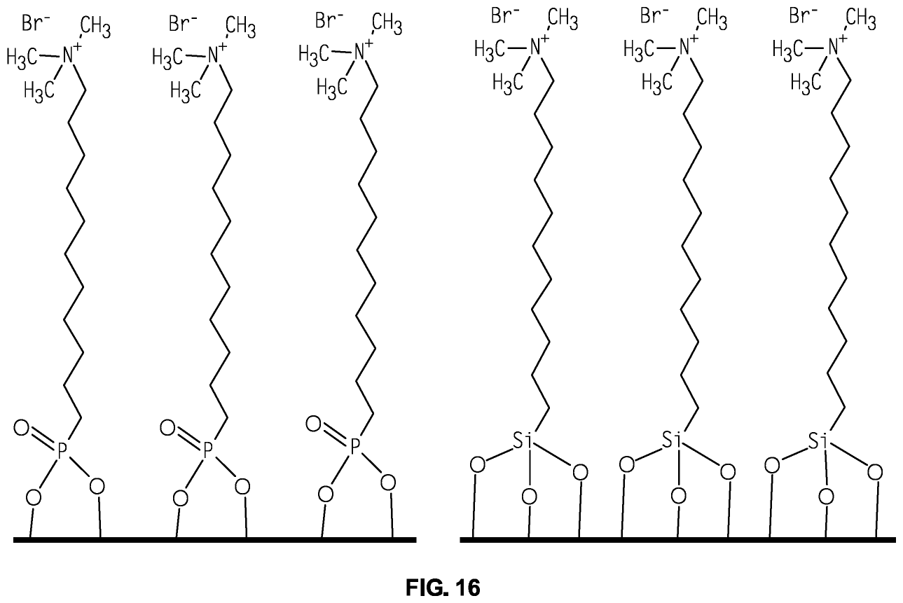

FIG. 16 illustrates examples of the self-assembled monolayers bound to the oxidized surface (e.g., the cathode substrate) using two different examples of halogen complexing agents as described herein. In the example on the left, the halogen complexing agent comprises an R^{D} group with an alkyl chain having a phosphonic acid terminal functional group at one end and on the other end, it is attached to a quaternary ammonium halide. When such halogen complexing agents are exposed to an oxidic surface (e.g., the cathode substrate), the phosphonic acid will bind to the oxygen and they will self-assemble to form a single molecule thick film where the quaternary ammonium halide group (the chosen group on the other end) coats the oxidized surface (e.g., the cathode substrate). A similar result can be achieved if the halogen complexing agent is terminated in a silyl ether group instead of phosphonic acid, which is shown in the example on the right side of FIG. 16. Additionally, the silyl ether groups of the halogen complexing agents may polymerize during the process of contacting, depositing or coating the cathode substrate with the mixture containing the halogen complexing agent with the silyl ether group to form Si—O—Si (siloxane) linkages. These clusters of silanes may bind to the oxidized surface (e.g., the cathode substrate) in a monolayer or a multilayer formation.

As discussed above, below, and throughout the application, in some embodiments, the cathode substrate undergoes additional processing. For example, the cathode substrate is oxidized, carbonized, graphitized, activated, or any combination thereof.

B. Process

Another aspect of the present disclosure relates to a process for manufacturing a bipolar electrode. The process comprises the steps of mixing a halogen complexing agent and a solvent to form a mixture; contacting a cathode substrate with the mixture to form a loaded cathode substrate, wherein the cathode substrate is loaded with the mixture; and contacting at least a portion of the loaded cathode substrate with a cathodic side of a bipolar electrode plate to form the bipolar electrode. The loaded cathode substrate is such that the cathode substrate is chemically bonded with the halogen complexing agent. The halogen complexing agent has a structure

of Formula (I): Q⁺(R^{A})(R^{B})(R^{C})(R^{D})X⁻, wherein the variables Q, R^{A}, R^{B}, R^{C}, R^{D}, and X are as defined herein.

The halogen complexing agent, the cathode substrate, the bipolar electrode plate are as described above and throughout the application. In some embodiments, the halogen complexing agent is (12-dodecylphosphonic acid)triethylammonium bromide, trimethyl[3-(trimethoxysilyl)propyl] ammonium chloride, N-trimethoxysilylproply-N,N,N-tri-n-butylammonium bromide, N-trimethoxysilylundecyl-N,N,N-tri-n-butylammonium bromide, (12-Dodecylphosphonic acid)triethylammonium chloride, (12-Dodecylphosphonic acid)pyridinium bromide, (12-Dodecylphosphonic acid)N,N-Dimethyl-N-octadecyl ammonium bromide, 1-Methyl-3-(dodecylphosphonic acid)imidazolium bromide, or 1-Methyl-3-(hexylphosphonic acid)imidazolium bromide.

A halogen complexing agent and a solvent are mixed to form a mixture. The solvent may be any suitable solvent that allows for dispersion of the halogen complexing agent, loading of the cathode substrate, and evaporation upon drying of the cathode substrate. In some embodiments, the solvent comprises water. In some embodiments, the solvent comprises a solvent miscible in water. In some embodiments, the solvent comprises water, alcohol, or any combination thereof. In some embodiments, the alcohol is a primary, a secondary, or a tertiary alkyl alcohol. Non-limiting examples of the solvent include, e.g., water, methanol, ethanol, propanol, isopropyl alcohol, acetone, dimethyl formamide, acetonitrile, dimethyl sulfoxide, or combinations thereof. The concentration of the halogen complexing agent in the mixture is from about 0.01 wt. % to about 1 wt. % and a concentration of the solvent in the mixture is from about 99 wt. % to about 99.99 wt. %.

The mixture comprising the halogen complexing agent and the solvent is contacted with the cathode substrate to form a loaded cathode substrate, wherein the cathode substrate is loaded with the mixture. The loaded cathode substrate is such that the cathode substrate is chemically bonded with the halogen complexing agent. The halogen complexing agent may be in, on, or both in and on the cathode substrate. The mixture comprising the halogen complexing agent and the solvent is applied, contacted, deposited, or loaded onto the cathode substrate to generate the loaded cathode substrate. In some embodiments, the mixture is sprayed onto the cathode substrate, and in others, the cathode substrate is dip coated in the mixture. In some embodiments, the cathode substrate is dipped into the mixture comprising the halogen complexing agent and the solvent.

In some embodiments, the process further comprises drying the loaded cathode substrate. Drying may be done to allow the solvent from the mixture to evaporate. The drying may be done under vacuum or in a vented environment, such as a laboratory hood. Fast-evaporating solvents (e.g., acetone) may be selected in order to speed up drying time. In some embodiments, the process further comprises sonicating the mixture before and/or during contacting the cathode substrate with the mixture. In some embodiments, the cathode substrate is dipped in the mixture. For example, the cathode substrate is dipped and held submerged in the mixture for about 15 seconds. In some embodiments, the mixture is stirred or agitated before and/or during contacting the cathode substrate with the mixture.

In some embodiments, the process further comprises sonicating the mixture of the halogen complexing agent and the solvent before, during, or before and during contacting the cathode substrate with the mixture.

In some embodiments, the process further comprises an additional treatment of the cathode substrate. The treatment may include one or more of oxidizing, carbonizing, activating, or graphitizing process. The oxidation or activation treatments modify the cathode substrate to increase its ability to bind to the halogen complexing agent. For example, oxidation or activation of the surface of the cathode substrate increases the surface concentration of oxygen, enabling the formation of stronger bonds between the surface of the cathode substrate and the halogen complexing agent. The carbonization or graphitization treatments increase the chemical stability and electrical conductivity of the cathode substrate, which improves the performance and longevity of the battery in operation.

In some embodiments, the additional treatment step occurs before, during, or before and during contacting the cathode substrate with the mixture of the halogen complexing agent and the solvent. In some embodiments, the additional treatment step occurs before contacting the cathode substrate with the mixture of the halogen complexing agent and the solvent.

The additional treatment steps of oxidizing, activating, carbonizing, and/or graphitizing can be performed in any order. The oxidizing and activation processes may involve treating the cathode substrate with oxygen or air environment. The oxidation process may include chemical, electrochemical, or thermal methods, all of which are well-known to those having ordinary skill in the art. Carbonizing and graphitizing processes may involve one or more of a wide variety of coating processes to provide functionality. For example, dip, slot-die coating (including multilayer), spray, comma bar, reverse roll and meyer rod processes. Converting equipment including slitters, calenders, sheeters, and hot presses, and die-cutters may also be used. In some embodiments, the treatment is performed at high temperatures, e.g., greater than about 1000° C. or up to about 3000° C.

Carbonizing and/or graphitizing may also involve chemical vapor deposition (CVD) of carbon or graphite. Typical CVD processes deposit amorphous pyrolytic carbon (PC) onto carbon substrates including carbon fabrics, papers, and tow. Substantially uniform layers may be applied in thicknesses ranging from nanometers to micrometers.

In some embodiments, the cathode substrate is pre-treated with a strong base (such as KOH) before contacting the cathode substrate with the mixture of the halogen complexing agent and the solvent.

The cathode substrate is as described above and throughout the application. In some embodiments, the cathode substrate comprises carbon felt, graphite felt, packed carbon powder, graphite powder, expanded graphite powder, carbon foam, aerogel carbon, xerogel carbon, sol-gelated carbon, carbon cloth, carbon paper, or reticulated carbon.

In some embodiments, the cathode substrate comprises carbon felt. In some embodiments, the carbon felt is oxidized, carbonized, graphitized, activated, or any combination thereof. The structure of textiles and composites of textiles can be engineered to create carbon felts suitable for use in electrochemical applications. In some embodiments, the carbon felt is formed from a precursor material comprising either polyacrylonitrile (PAN), rayon or pitch. In some embodiments, the carbon felt is a directly activated non-woven fiber with high surface area. The carbon felt may have such features as large adsorption volume, fast adsorption speed, heat-resistance, acid resistance, and alkaline resistance.

In some embodiments, the carbon felt is loaded with a concentration of the halogen complexing agent of from about 0.1 gram to about 500 grams per kilogram of the carbon felt. For example, the carbon felt is loaded with a concentration of the halogen complexing agent of from about 1 gram to about 100 grams per kilogram of the carbon felt.

At least a portion of the loaded cathode substrate is incorporated onto a bipolar electrode, which may correspondingly be incorporated into the electrochemical cells and the battery stacks described herein. To incorporate the loaded cathode substrate onto the bipolar electrode, the loaded cathode substrate contacts or at least a portion of the loaded cathode substrate contacts the cathodic surface of a bipolar electrode plate to form the bipolar electrode,

The bipolar electrode plate is as described above and throughout the application. In some embodiments, the bipolar electrode plate comprises a titanium material. The titanium material can be at least partially coated with titanium carbide. In some embodiments, the bipolar electrode plate comprises titanium, TiC, TiN, graphite, or an electrically conductive plastic.

In some embodiments, an adhesive or a glue may be used to attach the loaded cathode substrate and the cathodic side of the bipolar electrode plate. The adhesive or glue is electrically conductive. In some embodiments, at least a portion of the cathodic surface is coated with an adhesive or a glue, and the loaded cathode substrate is placed on top of the adhesive of the glue, pressure (e.g., 3 psi, 5 psi, or the like) is applied to the top of the loaded cathode substrate, and the adhesive or glue is then cured or dried (e.g., for 1 hour).

In other embodiments, the cathode cage holds the loaded cathode substrate in contact with the cathodic side of the bipolar electrode plate. Suitable cathode cage configurations for holding the loaded cathode substrate in contact with the bipolar electrode plate are described above and throughout the application.

Any of an adhesive, glue, an electrically conductive bonding material, tape, or a cathode cage, or a combination thereof, may be used to incorporate the loaded cathode substrate onto the bipolar electrode plate. Therefore, it is possible to have a bipolar electrode (and corresponding electrochemical cell) with no cathode cage, where the adhesive, glue, electrically conductive bonding material, or tape is used to maintain contact. Likewise, it is possible to have a bipolar electrode (and corresponding electrochemical cell) with no adhesive, glue, electrically conductive bonding material, or tape, where the cathode cage is used to maintain contact.

Another aspect of the present disclosure relates to an electrochemical cell comprising: a bipolar electrode comprising a bipolar electrode plate having a cathode surface and an anode surface, wherein the cathode surface opposes the anode surface; and a cathode substrate loaded with a halogen complexing agent, wherein the cathode surface at least partially contacts the cathode substrate; and an aqueous zinc-halide electrolyte, wherein the halogen complexing agent has a structure of Formula (I): Q⁺(R^{A})(R^{B})(R^{C})(R^{D})X⁻, wherein the variables Q, R^{A}, R^{B}, R^{C}, R^{D}, and X are as defined herein. As discussed above, the bipolar electrode as described herein may correspondingly be incorporated into the electrochemical cells described herein by stacking the electrodes using frame members as spacers, terminating the stack with terminal assemblies on both ends.

Yet another aspect of the present disclosure relates to a battery stack comprising: a pair of terminal assemblies; at least one bipolar electrode interposed between the pair of terminal assemblies wherein the bipolar electrode comprises: a bipolar electrode plate; a cathode substrate loaded with a halogen complexing agent; and an aqueous zinc-halide electrolyte in contact with the bipolar electrode plate and the cathode substrate, wherein the halogen complexing agent has a structure of Formula (I): Q⁺(R^{A})(R^{B})(R^{C})(R^{D})X⁻, wherein the variables Q, R^{A}, R^{B}, R^{C}, R^{D}, and are as defined herein. As discussed above, the bipolar electrode described herein may correspondingly be incorporated into the electrochemical cells as described herein, which in turn may correspondingly be incorporated into the battery stack described herein by stacking the electrodes using frame members as spacers, terminating the stack with terminal assemblies on both ends.

In some embodiments, a self-discharge rate of the battery stack described herein is reduced by about 29% to about 34% in a single cycle compared to an equivalent battery stack without a halogen complexing agent.

### IV. EXAMPLES

### Example 1: Preparation of Carbon Felt Substrate Loaded with Silane-Based Halogen Complexing Agent

A solution was prepared containing trimethyl {[3-(trimethoxysilyl)propyl]}ammonium chloride (13 mM) in 1:1 (v/v) methanol and water. Three equivalent pieces of 6 mm thick, dry PAN-fiber-based carbon felt—which was pre-modified by carbonizing, activating and graphitizing processes—were dipped in the mixture and submerged for about 15 seconds. The pieces were removed and the excess mixture was drained. Each piece was placed on a drying rack and dried in a fume hood for 72 hours. The felts were then placed in an oven held at 60° C. for 1 hour.

### Example 2: Preparation of Carbon Felt Substrate Loaded with Phosphonate-Based Halogen Complexing Agent

A solution of (12-dodecylphosphonic acid)triethylammonium bromide (0.231 mM) in ethanol was prepared. Three equivalent pieces of 6 mm thick, dry PAN-fiber-based carbon felt— which was pre-modified by carbonizing, activating and graphitizing processes—were dipped in the mixture and submerged for about 15 seconds. The pieces were removed and the excess mixture was drained. Each piece was placed on a drying rack and dried in a fume hood for 24 hours. The felts were then placed in an oven held at 60° C. for 1 hour.

### Example 3: Preparation of Test Cells

Test cells were assembled using titanium carbide coated titanium metal current collectors that were formed into plates. Anode and cathode plates were placed in a parallel configuration separated by a 12 mm thick high-density polyethylene frame containing an embedded sealing ring that allowed the cell to be sealed by compressing the components between two opposing steel compression plates. Prior to cell assembly, the above carbon felts loaded with halogen complexing agents or untreated control carbon felts were attached to cathode titanium current collectors using 13 ml of an electrically conductive, acetone-based glue. Assembled cells were filled with electrolyte composed primarily of zinc bromide and water and also containing a small quantity of potassium halide salts and tetraalkylammonium bromide salts.

### Example 4: Discharge Capacity of the Test Cells

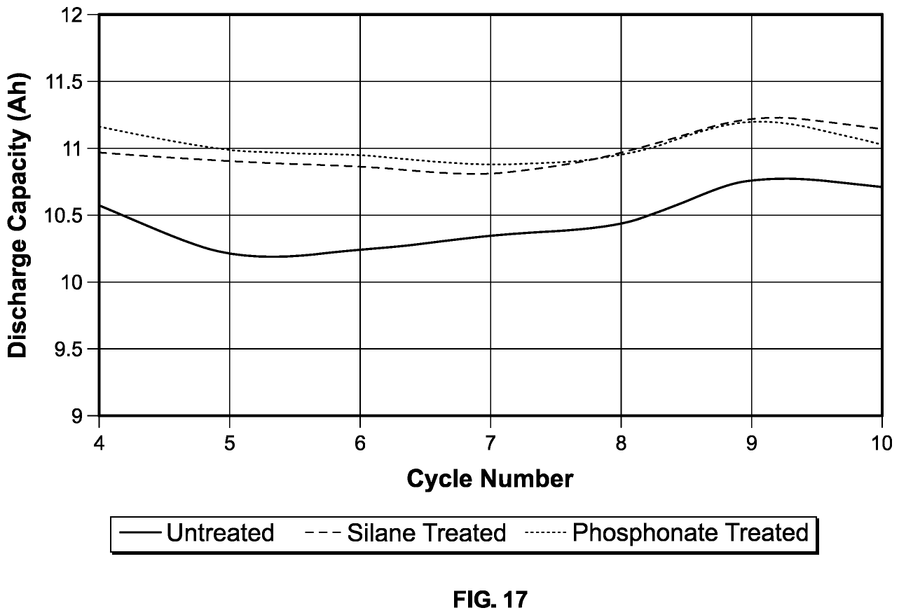

The test cells were cycled using an Arbin Instruments battery cycler. The cells were charged at a constant power of 4 W to a capacity of 13 Ah. The charge voltage limit was 2.4 V. The cells were discharged at a constant power of 4 W until the voltage reached 1.1 V. FIG. 17 shows the average discharge capacity vs. cycle index for three populations of cells prepared in triplicate containing either untreated control carbon felt (Untreated) or carbon felts loaded with trimethyl{[3-(trimethoxysilyl)propyl]}ammonium chloride (Silane) or (12-dodecylphosphonic acid)triethylammonium bromide (Phosphonate). The discharge capacity of the cells containing treated carbon felt is higher than that of the control carbon felt, suggesting that the carbon felt treatment increases the availability of charged material.

### Example 5: Testing the Rate of Self-Discharge of the Test Cells

To test the rate of self-discharge for different populations of test cells, the rest time between the end of the charge step (top of charge) and the beginning of discharge was varied cycle-to-cycle between 0.08 h-4 h. The self-discharge rate is defined as the rate of capacity loss as a function of the top of charge rest time. Table 1 shows the reduction in the rate of self-discharge for carbon felts loaded with trimethyl{[3-(trimethoxysilyl)propyl]}ammonium chloride (Silane) or (12-dodecylphosphonic acid)triethylammonium bromide (Phosphonate) compared to the control population containing untreated carbon felt. The reduction in self-discharge rate suggests that the carbon felt treatment reduces the crossover of bromine from the cathode to the anode where it can react with zinc, reducing the discharge capacity.

TABLE 1

| Functional Group Introduced | Reduction in Self-Discharge Rate (%) |
|---|---|
| Silane | 28.9 |
| Phosphonate | 33.8 |

In a first aspect, described is a bipolar electrode comprising: a bipolar electrode plate having a cathode surface and an anode surface, wherein the cathode surface opposes the anode surface; and a cathode substrate loaded with a halogen complexing agent, wherein the cathode surface at least partially contacts the cathode substrate, wherein the halogen complexing agent has a structure of Formula (I): Q⁺(R^{A})(R^{B})(R^{C})(R^{D})X⁻ wherein: Q is N, P, or S; R^{A}, R^{B}, and R^{C} are each independently hydrogen or optionally substituted branched or unbranched C₁ to C₂₀ alkyl, allyl, or vinyl, or any two of R^{A-C} join with Q to form a C₃ to C₆ cyclic group optionally comprising one or more additional heteroatoms selected from N, P, and O; R^{D} is optionally substituted branched or unbranched C₁ to C₂₀ alkyl, allyl, vinyl, or C₃ to C₆ cyclic group optionally comprising one or more heteroatoms selected from N, P, and O, wherein R^{D} has a terminal functional group; and X⁻ is Cl⁻, Br⁻, or I⁻, wherein the functional group is —PO₃H₂, —Si(R^{E})(R^{F})(R^{G}), or —C(R^{H})(R^{I})Y, wherein: R^{E}, R^{F}, and R^{G} are each independently OCH₃, OCH₂CH₃, CH₃, or Cl, R^{H} and R^{I} are each independently H or C₁ to C₂₀ alkyl, and Y is a halide.

In the above first aspect, each optional substituent is independently halide, hydroxy, carboxylic acid, ether, amine, amide, or ammonium.

In any of the above first aspects, the cathode substrate comprises carbon felt, graphite felt, packed carbon powder, graphite powder, expanded graphite powder, carbon foam, aerogel carbon, xerogel carbon, sol-gelated carbon, carbon cloth, carbon paper, or reticulated carbon.

In any of the above first aspects, the cathode substrate comprises carbon felt.

In any of the above first aspects, the cathode substrate comprises packed carbon powder.

In any of the above first aspects, the carbon powder is activated carbon, carbon black, expanded graphite, graphite, or a combination of two or more thereof.

In any of the above first aspects, the cathode surface at least partially contacts the cathode substrate using an adhesive, an electrically conductive bonding material, a tape, a mechanical cage, or combination thereof.

In any of the above first aspects, the cathode substrate is oxidized, carbonized, graphitized, activated, or any combination thereof.

In any of the above first aspects, the loaded cathode substrate is such that the cathode substrate is chemically bonded with the halogen complexing agent.

In any of the above first aspects, the cathode substrate is chemically bonded with a monomer of the halogen complexing agent.

In any of the above first aspects, the cathode substrate is chemically bonded with a polymer of the halogen complexing agent.

In any of the above first aspects, the halogen complexing agent is (12-dodecylphosphonic acid)triethylammonium bromide, trimethyl[3-(trimethoxysilyl)propyl] ammonium chloride, N-trimethoxysilylproply-N,N,N-tri-n-butylammonium bromide, N-trimethoxysilylundecyl-N,N,N-tri-n-butylammonium bromide, (12-Dodecylphosphonic acid)triethylammonium chloride, (12-Dodecylphosphonic acid)pyridinium bromide, (12-Dodecylphosphonic acid)N,N-Dimethyl-N-octadecyl ammonium bromide, 1-Methyl-3-(dodecylphosphonic acid)imidazolium bromide, or 1-Methyl-3-(hexylphosphonic acid)imidazolium bromide.

In any of the above first aspects, the bipolar electrode plate comprises a titanium material.

In any of the above first aspects, the titanium material is at least partially coated with titanium carbide.

In any of the above first aspects, the bipolar electrode plate comprises titanium, TiC, TiN, graphite, or an electrically conductive plastic.

In a second aspect, described is a process for manufacturing a bipolar electrode, the process comprising: mixing a halogen complexing agent and a solvent to form a mixture; contacting a cathode substrate with the mixture to form a loaded cathode substrate, wherein the cathode substrate is loaded with the mixture; and contacting at least a portion of the loaded cathode substrate with a cathodic side of a bipolar electrode plate to form the bipolar electrode. The halogen complexing agent has a structure of Formula (I): Q⁺(R^{A})(R^{B})(R^{C})(R^{D})X⁻, wherein: Q is N, P, or S; R^{A}, R^{B}, and R^{C} are each independently hydrogen or optionally substituted branched or unbranched C₁ to C₂₀ alkyl, allyl, or vinyl, or any two of R^{A-C} join with Q to form a C₃ to C₆ cyclic group optionally comprising one or more additional heteroatoms selected from N, P, and O; R^{D} is optionally substituted branched or unbranched C₁ to C₂₀ alkyl, allyl, vinyl, or C₃ to C₆ cyclic group optionally comprising one or more heteroatoms selected from N, P, and O, wherein R^{D} has a terminal functional group; and X⁻ is F⁻, Cl⁻, Br⁻, or I⁻, wherein the functional group is —PO₃H₂, —Si(R^{E})(R^{F})(R^{G}), or —C(R^{H})(R^{I})Y, wherein: R^{E}, R^{F}, and R^{G} are each independently OCH₃, OCH₂CH₃, CH₃, or Cl, R^{H} and R^{I} are each independently H or C₁ to C₂₀ alkyl, and Y is a halide.

In the above second aspect, the process further comprises drying the loaded cathode substrate.

In any of the above second aspects, the process further comprises sonicating the mixture before, during, or before and during contacting the cathode substrate with the mixture.

In any of the above second aspects, the solvent is water, alcohol, or combination thereof.

In any of the above second aspects, the cathode substrate is dipped in the mixture.

In any of the above second aspects, the process further comprises treating the cathode substrate, wherein the treating is selected from oxidizing, carbonizing, activating, graphitizing, or any combination thereof.

In any of the above second aspects, the oxidizing, carbonizing, activating, graphitizing, or any combination thereof occurs before contacting the cathode substrate with the mixture.

In any of the above second aspects, the halogen complexing agent in the mixture is a monomer.

In any of the above second aspects, the loaded cathode substrate is such that the cathode substrate is chemically bonded with the halogen complexing agent.

In any of the above second aspects, the cathode substrate is chemically bonded with a monomer of the halogen complexing agent.

In any of the above second aspects, the cathode substrate is chemically bonded with a polymer of the halogen complexing agent.

In a third aspect, described is an electrochemical cell comprising: a bipolar electrode comprising a bipolar electrode plate having a cathode surface and an anode surface, wherein the cathode surface opposes the anode surface; and a cathode substrate loaded with a halogen complexing agent, wherein the cathode surface at least partially contacts the cathode substrate; and an aqueous zinc-halide electrolyte. The halogen complexing agent has a structure of Formula (I): Q⁺(R^{A})(R^{B})(R^{C})(R^{D})X⁻ wherein: Q is N, P, or S; R^{A}, R^{B}, and R^{C} are each independently hydrogen or optionally substituted branched or unbranched C₁ to C₂₀ alkyl, allyl, or vinyl, or any two of R^{A-C} join with Q to form a C₃ to C₆ cyclic group optionally comprising one or more additional heteroatoms selected from N, P, and O; R^{D} is optionally substituted branched or unbranched C₁ to C₂P alkyl, allyl, vinyl, or C₃ to C₆ cyclic group optionally comprising one or more heteroatoms selected from N, P, and O, wherein R^{D} has a terminal functional group; and X⁻ is F⁻, Cl⁻, Br⁻, or I⁻, wherein the functional group is —PO₃H₂, —Si(R^{E})(R^{F})(R^{G}), or —C(R^{H})(R^{I})Y, wherein: R^{E}, R^{F}, and R^{G} are each independently OCH₃, OCH₂CH₃, CH₃, or Cl, R^{H} and R^{I} are each independently H or C₁ to C₂₀ alkyl, and Y is a halide.

In the above third aspect, the cathode substrate comprises carbon felt, graphite felt, packed carbon powder, graphite powder, expanded graphite powder, carbon foam, aerogel carbon, xerogel carbon, sol-gelated carbon, carbon cloth, carbon paper, or reticulated carbon.

In any of the above third aspects, the halogen complexing agent is (12-dodecylphosphonic acid)triethylammonium bromide, trimethyl[3-(trimethoxysilyl)propyl] ammonium chloride, N-trimethoxysilylproply-N,N,N-tri-n-butylammonium bromide, N-trimethoxysilylundecyl-N,N,N-tri-n-butylammonium bromide, (12-Dodecylphosphonic acid)triethylammonium chloride, (12-Dodecylphosphonic acid)pyridinium bromide, (12-Dodecylphosphonic acid)N,N-Dimethyl-N-octadecyl ammonium bromide, 1-Methyl-3-(dodecylphosphonic acid)imidazolium bromide, or 1-Methyl-3-(hexylphosphonic acid)imidazolium bromide.

In any of the above third aspects, the bipolar electrode plate comprises titanium, TiC, TiN, graphite, or an electrically conductive plastic.

In any of the above third aspects, the aqueous zinc-halide electrolyte comprises from about 25 wt. % to about 70 wt. % of ZnBr₂; from about 5 wt. % to about 50 wt. % of water; and from about 0.05 wt. % to about 10 wt. % of one or more quaternary ammonium agents.

In any of the above third aspects, the aqueous zinc-halide electrolyte comprises from about 25 wt. % to about 40 wt. % of ZnBr₂; from about 25 wt. % to about 50 wt. % water; from about 5 wt. % to about 15 wt. % of KBr; from about 5 wt. % to about 15 wt. % of KCl; and from about 0.5 wt. % to about 10 wt. % of the one or more quaternary ammonium agents.

In any of the above third aspects, the one or more quaternary ammonium agents comprises a quaternary agent selected from the group consisting of ammonium chloride, tetraethylammonium bromide, tetraethyl ammonium chloride, trimethylpropylammonium bromide, triethylmethyl ammonium chloride, trimethylpropylammonium chloride, butyltrimethylammonium chloride, trimethylethyl ammonium chloride, N-methyl-N-ethylmorpholinium bromide, N-methyl-N-ethylmorpholinium bromide (MEMBr), 1-ethyl-1-methylmorpholinium bromide, N-methyl-N-butylmorpholinium bromide, N-methyl-N-ethylpyrrolidinium bromide, N,N,N-triethyl-N-propylammonium bromide, N-ethyl-N-propylpyrrolidinium bromide, N-propyl-N-butylpyrrolidinium bromide, N-methyl-N-butylpyrrolidinium bromide, 1-methyl-1-butyl pyrrolidinium bromide, N-ethyl-N-(2-chloroethyl)pyrrolidinium bromide, N-methyl-N-hexylpyrrolidinium bromide, N-methyl-N-pentylpyrrolidinium bromide, N-ethyl-N-pentyl pyrrolidinium bromide, N-ethyl-N-butyl pyrrolidinium bromide, trimethylene-bis(N-methyl pyrrolidinium) dibromide, N-butyl-N-pentyl pyrrolidinium bromide, N-methyl-N-propylpyrrolidinium bromide, N-propyl-N-pentylpyrrolidinium bromide, 1-ethyl-4-methyl pyridinium bromide, 1-ethyl-2-methyl pyridinium bromide, 1-butyl-3-methylpyridinium bromide, cetyltrimethylammonium bromide, cetyltrimethylammonium chloride, cetyltriethylammonium bromide, and any combination thereof.

In any of the above third aspects, the one or more quaternary ammonium agents comprises an alkyl substituted pyridinium chloride, an alkyl substituted pyridinium bromide, an alkyl substituted morpholinium chloride, an alkyl substituted morpholinium bromide, an alkyl substituted pyrrolidinium chloride, an alkyl substituted pyrrolidinium bromide, or any combination thereof.

In a fourth aspect, described is a battery stack comprising: a pair of terminal assemblies; at least one bipolar electrode interposed between the pair of terminal assemblies, wherein the bipolar electrode comprises: a bipolar electrode plate; a cathode substrate loaded with a halogen complexing agent; and an aqueous zinc-halide electrolyte in contact with the bipolar electrode plate and the cathode substrate. The halogen complexing agent has a structure of Formula (I): Q⁺(R^{A})(R^{B})(R^{C})(R^{D})X⁻, wherein: Q is N, P, or S; R^{A}, R^{B}, and R^{C} are each independently hydrogen or optionally substituted branched or unbranched C₁ to C₂₀ alkyl, allyl, or vinyl, or any two of R^{A-C} join with Q to form a C₃ to C₆ cyclic group optionally comprising one or more additional heteroatoms selected from N, P, and O; R^{D} is optionally substituted branched or unbranched C₁ to C₂₀ alkyl, allyl, vinyl, or C₃ to C₆ cyclic group optionally comprising one or more heteroatoms selected from N, P, and O, wherein R^{D} has a terminal functional group; and X⁻ is F⁻, Cl⁻, Br⁻, or I⁻, wherein the functional group is —PO₃H₂, —Si(R^{E})(R^{F})(R^{G}), or —C(R^{H})(R^{I})Y, wherein: R^{E}, R^{F}, and R^{G} are each independently OCH₃, OCH₂CH₃, Cl or CH₃, R^{H} and R^{I} are each independently H or C₁ to C₂₀ alkyl, and Y is a halide.

In the above fourth aspect, the cathode substrate comprises carbon felt, graphite felt, packed carbon powder, graphite powder, expanded graphite powder, carbon foam, aerogel carbon, xerogel carbon, sol-gelated carbon, carbon cloth, carbon paper, or reticulated carbon.

In any of the above fourth aspects, the halogen complexing agent is (12-dodecylphosphonic acid)triethylammonium bromide, trimethyl[3-(trimethoxysilyl)propyl] ammonium chloride, N-trimethoxysilylproply-N,N,N-tri-n-butylammonium bromide, N-trimethoxysilylundecyl-N,N,N-tri-n-butylammonium bromide, (12-Dodecylphosphonic acid)triethylammonium chloride, (12-Dodecylphosphonic acid)pyridinium bromide, (12-Dodecylphosphonic acid)N,N-Dimethyl-N-octadecyl ammonium bromide, 1-Methyl-3-(dodecylphosphonic acid)imidazolium bromide, or 1-Methyl-3-(hexylphosphonic acid)imidazolium bromide.

In any of the above fourth aspects, the bipolar electrode plate comprises titanium, TiC, TiN, graphite, or an electrically conductive plastic.

In any of the above fourth aspects, the aqueous zinc-halide electrolyte comprises from about 25 wt. % to about 70 wt. % of ZnBr₂; from about 5 wt. % to about 50 wt. % of water; and from about 0.05 wt. % to about 10 wt. % of one or more quaternary ammonium agents.

In any of the above fourth aspects, the aqueous zinc-halide electrolyte comprises from about 25 wt. % to about 40 wt. % of ZnBr₂; from about 25 wt. % to about 50 wt. % water; from about 5 wt. % to about 15 wt. % of KBr; from about 5 wt. % to about 15 wt. % of KCl; and from about 0.5 wt. % to about 10 wt. % of the one or more quaternary ammonium agents.

In any of the above fourth aspects, the one or more quaternary ammonium agents comprises a quaternary agent selected from the group consisting of ammonium chloride, tetraethylammonium bromide, tetraethyl ammonium chloride, trimethylpropylammonium bromide, triethylmethyl ammonium chloride, trimethylpropylammonium chloride, butyltrimethylammonium chloride, trimethylethyl ammonium chloride, N-methyl-N-ethylmorpholinium bromide, N-methyl-N-ethylmorpholinium bromide (MEMBr), 1-ethyl-1-methylmorpholinium bromide, N-methyl-N-butylmorpholinium bromide, N-methyl-N-ethylpyrrolidinium bromide, N,N,N-triethyl-N-propylammonium bromide, N-ethyl-N-propylpyrrolidinium bromide, N-propyl-N-butylpyrrolidinium bromide, N-methyl-N-butylpyrrolidinium bromide, 1-methyl-1-butyl pyrrolidinium bromide, N-ethyl-N-(2-chloroethyl)pyrrolidinium bromide, N-methyl-N-hexylpyrrolidinium bromide, N-methyl-N-pentylpyrrolidinium bromide, N-ethyl-N-pentyl pyrrolidinium bromide, N-ethyl-N-butyl pyrrolidinium bromide, trimethylene-bis(N-methyl pyrrolidinium) dibromide, N-butyl-N-pentyl pyrrolidinium bromide, N-methyl-N-propylpyrrolidinium bromide, N-propyl-N-pentylpyrrolidinium bromide, 1-ethyl-4-methyl pyridinium bromide, 1-ethyl-2-methyl pyridinium bromide, 1-butyl-3-methylpyridinium bromide, cetyltrimethylammonium bromide, cetyltrimethylammonium chloride, cetyltriethylammonium bromide, and any combination thereof.

In any of the above fourth aspects, the one or more quaternary ammonium agents comprises an alkyl substituted pyridinium chloride, an alkyl substituted pyridinium bromide, an alkyl substituted morpholinium chloride, an alkyl substituted morpholinium bromide, an alkyl substituted pyrrolidinium chloride, an alkyl substituted pyrrolidinium bromide, or any combination thereof.

In any of the above fourth aspects, a self-discharge rate of the battery stack is reduced by about 29% to about 34% in a single cycle compared to an equivalent battery stack without the halogen complexing agent.

From the foregoing and with reference to the various figure drawings, those skilled in the art will appreciate that certain modifications can also be made to the present disclosure without departing from the scope of the same. While several embodiments of the disclosure have been shown in the drawings, it is not intended that the disclosure be limited thereto, as it is intended that the disclosure be as broad in scope as the art will allow and that the specification be read likewise. Therefore, the above description should not be construed as limiting, but merely as exemplifications of particular embodiments. Those skilled in the art will envision other modifications within the scope and spirit of the claims appended hereto.

1. A bipolar electrode comprising:
a bipolar electrode plate having a cathode surface and an anode surface, wherein the cathode surface opposes the anode surface; and
a cathode substrate loaded with a halogen complexing agent, wherein the cathode surface at least partially contacts the cathode substrate,
wherein the halogen complexing agent has a structure of Formula (I):
Q⁺(R^{A})(R^{B})(R^{C})(R^{D})X⁻,
wherein:
Q is N, P, or S;
R^{A}, R^{B}, and R^{C} are each independently hydrogen, or unsubstituted or substituted, branched or unbranched, C₁ to C₂₀ alkyl, allyl, or vinyl, or any two of R^{A-C} join with Q to form a C₃ to C₆ heterocyclic group optionally comprising one or more additional heteroatoms selected from N, P, and O;
R^{D} is an unsubstituted or substituted, branched or unbranched, C₁ to C₂₀ alkyl, allyl, vinyl, or C₃ to C₆ cyclic group optionally comprising one or more heteroatoms selected from N, P, and O, wherein R^{D} further comprises a terminal functional group; and
X is F, Cl, Br, or I,
wherein the terminal functional group of R^{D} is one of —PO₃H₂, —Si(R^{E})(R^{F})(R^{G}), or —C(R^{H})(R^{I})Y,
wherein:
R^{E}, R^{F}, and R^{G} are each independently one of OCH₃, OCH₂CH₃, CH₃, or
R^{H} and R^{I} are each independently one of H or C₁ to C₂₀ alkyl, and
Y is a halide.

2. The bipolar electrode of claim 1, wherein substituents for R^{A-D} are each independently one of halide, hydroxy, carboxylic acid, ether, amine, amide, or ammonium.

3. The bipolar electrode of claim 1, wherein the cathode substrate comprises carbon felt, graphite felt, packed carbon powder, graphite powder, expanded graphite powder, carbon foam, aerogel carbon, xerogel carbon, sol-gelated carbon, carbon cloth, carbon paper, or reticulated carbon.

4. The bipolar electrode of claim 3, wherein the cathode substrate comprises carbon felt.

5. The bipolar electrode of claim 3, wherein the cathode substrate comprises packed carbon powder.

6. The bipolar electrode of claim 5, wherein the carbon powder is activated carbon, carbon black, expanded graphite, graphite, or a combination of two or more thereof.

7. The bipolar electrode of claim 5, wherein the cathode surface in contact with the cathode substrate is connected to the cathode substrate using an adhesive, an electrically conductive bonding material, a tape, a mechanical cage, or combination thereof.

8. The bipolar electrode of claim 1, wherein the cathode substrate is oxidized, carbonized, graphitized, activated, or any combination thereof.

9. The bipolar electrode of claim 1, wherein the cathode substrate loaded with a halogen complexing agent is chemically bonded with the halogen complexing agent.

10. The bipolar electrode of claim 9, wherein the cathode substrate is chemically bonded with a monomer of the halogen complexing agent.

11. The bipolar electrode of claim 9, wherein the cathode substrate is chemically bonded with a polymer of the halogen complexing agent.

12. The bipolar electrode of claim 1, wherein the halogen complexing agent is (12-dodecylphosphonic acid)triethylammonium bromide, trimethyl[3-(trimethoxysilyl)propyl] ammonium chloride, N-trimethoxysilylproply-N,N,N-tri-n-butylammonium bromide, N-trimethoxysilylundecyl-N,N,N-tri-n-butylammonium bromide, (12-Dodecylphosphonic acid)triethylammonium chloride, (12-Dodecylphosphonic acid)pyridinium bromide, (12-Dodecylphosphonic acid)N,N-Dimethyl-N-octadecyl ammonium bromide, 1-Methyl-3-(dodecylphosphonic acid)imidazolium bromide, or 1-Methyl-3-(hexylphosphonic acid)imidazolium bromide.

13. The bipolar electrode of claim 1, wherein the bipolar electrode plate comprises a titanium material.

14. The bipolar electrode of claim 13, wherein the titanium material is at least partially coated with titanium carbide.

15. The bipolar electrode of claim 1, wherein the bipolar electrode plate comprises titanium, TiC, TiN, graphite, or an electrically conductive plastic.

16.-26. (canceled)

27. An electrochemical cell comprising:
a bipolar electrode comprising a bipolar electrode plate having a cathode surface and an anode surface, wherein the cathode surface opposes the anode surface; and a cathode substrate loaded with a halogen complexing agent, wherein the cathode surface at least partially contacts the cathode substrate; and
an aqueous zinc-halide electrolyte,
wherein the halogen complexing agent has a structure of Formula (I):
Q⁺(R^{A})(R^{B})(R^{C})(R^{D})X⁻,
wherein:
Q is N, P, or S;
R^{A}, R^{B}, and R^{C} are each independently hydrogen, or unsubstituted or substituted, branched or unbranched, C₁ to C₂₀ alkyl, allyl, or vinyl, or any two of R^{A-C} join with Q to form a C₃ to C₆ heterocyclic group optionally comprising one or more additional heteroatoms selected from N, P, and O;
R^{D} is an unsubstituted or substituted, branched or unbranched, C₁ to C₂₀ alkyl, allyl, vinyl, or C₃ to C₆ cyclic group optionally comprising one or more heteroatoms selected from N, P, and O, wherein R^{D} further comprises a terminal functional group; and
X is F, Cl, Br, or I,
wherein the terminal functional group of R^{D} is one of —PO₃H₂, —Si(R^{E})(R^{F})(R^{C}), or —C(R^{H})(R^{I})Y,
wherein:
R^{E}, R^{F}, and IV are each independently one of OCH₃, OCH₂CH₃, CH₃, or Cl,
R^{H} and R^{I} are each independently one of H or C₁ to C₂₀ alkyl, and
Y is a halide.

28. The electrochemical cell of claim 27, wherein the cathode substrate comprises carbon felt, graphite felt, packed carbon powder, graphite powder, expanded graphite powder, carbon foam, aerogel carbon, xerogel carbon, sol-gelated carbon, carbon cloth, carbon paper, or reticulated carbon.

29. The electrochemical cell of claim 27, wherein the halogen complexing agent is (12-dodecylphosphonic acid)triethylammonium bromide, trimethyl[3-(trimethoxysilyl)propyl] ammonium chloride, N-trimethoxysilylproply-N,N,N-tri-n-butylammonium bromide, N-trimethoxysilylundecyl-N,N,N-tri-n-butylammonium bromide, (12-Dodecylphosphonic acid)triethylammonium chloride, (12-Dodecylphosphonic acid)pyridinium bromide, (12-Dodecylphosphonic acid)N,N-Dimethyl-N-octadecyl ammonium bromide, 1-Methyl-3-(dodecylphosphonic acid)imidazolium bromide, or 1-Methyl-3-(hexylphosphonic acid)imidazolium bromide.

30. The electrochemical cell of claim 27, wherein the bipolar electrode plate comprises titanium, TiC, TiN, graphite, or an electrically conductive plastic.

31. The electrochemical cell of claim 27, wherein the aqueous zinc-halide electrolyte comprises from about 25 wt. % to about 70 wt. % of ZnBr₂; from about 5 wt. % to about 50 wt. % of water; and from about 0.05 wt. % to about 10 wt. % of one or more quaternary ammonium agents.

32. The electrochemical cell of claim 31, wherein the aqueous zinc-halide electrolyte comprises from about 25 wt. % to about 40 wt. % of ZnBr₂; from about 25 wt. % to about 50 wt. % water; from about 5 wt. % to about 15 wt. % of KBr; from about 5 wt. % to about 15 wt. % of KCl; and from about 0.5 wt. % to about 10 wt. % of the one or more quaternary ammonium agents.

33. The electrochemical cell of claim 31, wherein the one or more quaternary ammonium agents comprises a quaternary agent selected from the group consisting of ammonium chloride, tetraethylammonium bromide, tetraethyl ammonium chloride, trimethylpropylammonium bromide, triethylmethyl ammonium chloride, trimethylpropylammonium chloride, butyltrimethylammonium chloride, trimethylethyl ammonium chloride, N-methyl-N-ethylmorpholinium bromide, N-methyl-N-ethylmorpholinium bromide (MEMBr), 1-ethyl-1-methylmorpholinium bromide, N-methyl-N-butylmorpholinium bromide, N-methyl-N-ethylpyrrolidinium bromide, N,N,N-triethyl-N-propylammonium bromide, N-ethyl-N-propylpyrrolidinium bromide, N-propyl-N-butylpyrrolidinium bromide, N-methyl-N-butylpyrrolidinium bromide, 1-methyl-1-butyl pyrrolidinium bromide, N-ethyl-N-(2-chloroethyl)pyrrolidinium bromide, N-methyl-N-hexylpyrrolidinium bromide, N-methyl-N-pentylpyrrolidinium bromide, N-ethyl-N-pentyl pyrrolidinium bromide, N-ethyl-N-butyl pyrrolidinium bromide, trimethylene-bis(N-methyl pyrrolidinium) dibromide, N-butyl-N-pentyl pyrrolidinium bromide, N-methyl-N-propylpyrrolidinium bromide, N-propyl-N-pentylpyrrolidinium bromide, 1-ethyl-4-methyl pyridinium bromide, 1-ethyl-2-methyl pyridinium bromide, 1-butyl-3-methylpyridinium bromide, cetyltrimethylammonium bromide, cetyltrimethylammonium chloride, cetyltriethylammonium bromide, and any combination thereof.

34. The electrochemical cell of claim 31, wherein the one or more quaternary ammonium agents comprises an alkyl substituted pyridinium chloride, an alkyl substituted pyridinium bromide, an alkyl substituted morpholinium chloride, an alkyl substituted morpholinium bromide, an alkyl substituted pyrrolidinium chloride, an alkyl substituted pyrrolidinium bromide, or any combination thereof.

35.-43. (canceled)
